(19) United States
(12) Patent Application Publication
(10) Pub. No.: US 2024/0351309 A1
(43) Pub. Date: Oct. 24, 2024

(54) LAMINATED STRUCTURE

(71) Applicant: SEKISUI CHEMICAL CO., LTD., Osaka (JP)

(72) Inventors: Asami NAGAI, Hasuda-shi, Saitama (JP); Daisuke MUKOHATA, Hasuda-shi, Saitama (JP)

(73) Assignee: SEKISUI CHEMICAL CO., LTD., Osaka (JP)

(21) Appl. No.: 18/685,714

(22) PCT Filed: Sep. 30, 2022
(86) PCT No.: PCT/JP2022/036847

§ 371 Date: Feb. 22, 2024

(30) Foreign Application Priority Data
Sep. 30, 2021 (JP) 2021-161667
Sep. 30, 2021 (JP) 2021-161669

(51) Int. Cl. B32B 15/04; B32B 5/02; B32B 5/18; B32B 15/085; B32B 15/14; B32B 15/20

(52) U.S. Cl. CPC B32B 15/043; B32B 5/028; B32B 5/18; B32B 15/046; B32B 15/085; B32B 15/14; B32B 15/20; B32B 2250/05; B32B 2260/021; B32B 2260/046; B32B 2262/101; B32B 2266/025; B32B 2307/3065; B32B 2307/5825; B32B 2307/7376

(57) ABSTRACT

A laminated structure 1A includes a metal sheet 10A formed by laminating two or more metal layers 11, and a resin foam 20. The total thickness of the metal layers 11 in the metal sheet 10A, Ta (μm), and a thickness of the resin foam 20, Tb (mm), satisfy the relationship of the following formula (1). The present invention can provide a laminated structure having excellent flame retardancy. Ta/Tb≥0.70 (1)

### TECHNICAL FIELD

The present invention relates to a laminated structure used in the construction field.

### BACKGROUND ART

Foam is widely used in various ways in the fields of construction, civil engineering, electricity, automobiles, and the like. For example, in the construction field, foam is used as a thermal insulator. For a thermal insulator, it is important to minimize human and property damage in the event of a fire. For example, when the thermal insulator combusts easily, the fire spreads more. In addition, when the thermal insulator combusts easily, smoke tends to be produced, and the produced smoke blocks people's vision and makes it difficult for victims to evacuate. As a result, the human and property damage caused by the fire is increased. Therefore, in recent years, thermal insulators tend to have higher performance requirements for safety, and incombustibility and flame retardancy are required.

Thermal insulators, which are mainly made of thermoplastic foam, are relatively inexpensive and tend to exhibit heat insulating properties, but on the other hand, the resin itself is often flammable, and flame retardancy is an issue. For this reason, for example, flame retardancy is imparted to the foam by blending a flame retardant with the foam (see, for example, Patent Literature 1).

### CITATION LIST

### Patent Literature

PTL1: JP 2017-145367 A

### SUMMARY OF INVENTION

### Technical Problem

However, just adding a flame retardant to the foam, as in Patent Literature 1, often fails to provide sufficient incombustibility.

Therefore, an object of the present invention is to provide a laminated structure having excellent flame retardancy.

### Solution to Problem

As a result of extensive studies, the present inventors found that a laminated structure having excellent flame retardancy can be obtained by laminating a metal sheet having a specific configuration on the surface of the resin foam. That is, the gist of the present invention is to provide the following [1] to [8].

[1] A laminated structure including:
a metal sheet formed by laminating two or more metal layers; and
a resin foam, wherein
a total thickness of the metal layers in the metal sheet, Ta (μm), and a thickness of the resin foam, Tb (mm), satisfy the relationship of the following formula (1):

$$Ta / Tb \geq 0.7 . \qquad ( 1 )$$

[2] The laminated structure according to the above [1], wherein each of the metal layers has a thickness of 10 μm or more.

[3] The laminated structure according to the above [1] or [2], wherein the metal sheet includes a resin layer provided between adjacent metal layers.

[4] The laminated structure according to any one of the above [1] to [3], wherein the resin foam has a thickness of from 25 to 76 mm.

[5] The laminated structure according to any one of the above [1] to [4], wherein the metal sheet further includes a cloth layer provided between adjacent metal layers.

[6] The laminated structure according to any one of the above [1] to [5], wherein at least one metal layer in the metal sheet is an aluminum layer.

[7] The laminated structure according to any one of the above [1] to [6], wherein the resin foam contains a flame retardant.

[8] The laminated structure according to any one of the above [1] to [7], further including a pressure-sensitive adhesion layer provided on a surface of the resin foam opposite to the surface facing the metal sheet.

[9] The laminated structure according to the above [1], wherein
the metal sheet includes a first resin layer provided between adjacent metal layers,
the thickness of each of the metal layers is 50 μm or less, and
the metal sheet has a tear strength of 0.5 N or more.

[10] The laminated structure according to the above [9], wherein each of the metal layers has a thickness of 10 μm or more.

[11] The laminated structure according to the above [9] or [10], wherein the resin constituting the first resin layer contains a polyolefin resin.

[12] The laminated structure according to any one of the above [9] to [11], including a second resin layer provided on one surface.

[13] The laminated structure according to the above [12], wherein the resin constituting the second resin layer contains a polyolefin resin.

[14] The laminated structure according to any one of the above [9] to [13], further including a reinforcement cloth layer provided between adjacent metal layers.

[15] The laminated structure according to any one of the above [9] to [14], wherein at least one metal layer is an aluminum layer.

[16] The laminated structure according to any one of the above [9] to [15], wherein a total thickness of the metal layers is 100 μm or less.

[17] The laminated structure according to any one of the above [9] to [16], wherein the metal sheet has a thickness of 400 μm or less.

[18] The laminated structure according to any one of the above [9] to [17], further including a pressure-sensitive adhesion layer provided on a surface of the resin foam opposite to the surface facing the metal sheet.

### Advantageous Effects of Invention

According to the present invention, a laminated structure having excellent flame retardancy can be provided.

### BRIEF DESCRIPTION OF DRAWINGS

FIG. 1 shows an example of a laminated structure.

FIG. 2 shows another example of a laminated structure.

FIG. 3 shows another example of a laminated structure.

FIG. 4 shows another example of a laminated structure.

FIG. 5 shows an example of a metal sheet.

FIG. 6 shows another example of a metal sheet.

FIG. 7 shows another example of a metal sheet.

FIG. 8 shows an example of a laminated structure.

FIG. 9 shows another example of a laminated structure.

FIG. 10 is a diagram for showing a tear strength test.

### DESCRIPTION OF EMBODIMENTS

### First Aspect

### [Laminated Structure]

The laminated structure according to the first aspect of the present invention includes a metal sheet formed by laminating two or more metal layers and a resin foam, wherein a total thickness of the metal layers in the metal sheet, Ta (μm), and a thickness of the resin foam, Tb (mm), satisfy the relationship of the following formula (1).

$$Ta / Tb \geq 0.7 \qquad ( 1 )$$

The laminated structure having the above structural configuration has excellent flame retardancy.

(Ratio (Ta/Tb) of total thickness of metal layers, Ta (μm), to thickness of resin foam, Tb (mm))

As shown by the above formula (1), the ratio (Ta/Tb) of the total thickness of the metal layers, Ta (μm), to the thickness of the resin foam, Tb (mm), is 0.70 or more. When the ratio (Ta/Tb) of the total thickness of the metal layers, Ta (μm), to the thickness of the resin foam, Tb (mm) is less than 0.70, the flame retardancy of the laminated structure may be insufficient. From such a viewpoint, the ratio (Ta/Tb) of the total thickness of the metal layers, Ta (μm), to the thickness of the resin foam, Tb (mm), is preferably 0.80 or more, more preferably 1.00 or more, further preferably 1.20 or more, and still further preferably 1.40 or more. On the other hand, from the viewpoint of securing the flexibility of the laminated structure and heat insulating properties, the ratio (Ta/Tb) of the total thickness of the metal layers, Ta (μm), to the thickness of the resin foam, Tb (mm), is preferably 10.00 or less, more preferably 8.00 or less, further preferably 5.00 or less, and still further preferably 2.00 or less.

The structural configuration of the laminated structure will now be described in more detail.

### <Resin Foam>

The resin contained in the resin foam in the laminated structure according to the first aspect of the present invention is preferably a thermoplastic resin. By using a thermoplastic resin as the resin contained in the resin foam, the processability and workability of the resin foam are good.

The resin contained in the resin foam is not particularly limited, but it is preferred to use a resin that can be used for a resin foam. Specific examples include polyvinyl chloride resins, silicone resins, acrylic resins, polyurethane resins, polyolefin resins, elastomers, and styrene resins. The elastomer may be a thermoplastic elastomer or a rubber component other than a thermoplastic elastomer. Among these, a polyolefin resin is preferred from the viewpoint of the processability and formability of the resin foam.

### (Degree of Crosslinking)

It is preferred to obtain the resin foam by cross-linking and foaming a resin composition containing a resin, and it is more preferred that the cross-linking of the resin composition is performed by an electron beam. In this case, a degree of crosslinking represented by the gel fraction of the resin foam obtained by cross-linking and foaming the resin composition is preferably from 15 to 70% by mass. By setting the degree of crosslinking of the resin foam within the above range, the mechanical strength, flexibility and formability of the resin foam can be improved in a well-balanced manner. From such a viewpoint, the degree of crosslinking of the resin foam is more preferably from 20 to 60% by mass, and further preferably from 25 to 50% by mass. The method for measuring the degree of crosslinking is as described in the examples below.

### (Apparent Density)

The resin foam has an apparent density of preferably from 10 to 100 kg/m³. By setting the apparent density to 10 kg/m³ or more, a certain mechanical strength can be imparted to the resin foam. Further, by setting the apparent density to 100 kg/m³ or less, appropriate heat insulating properties can be imparted. In addition, the resin foam also has excellent flexibility and the like, and workability is also good. From this viewpoint, the apparent density of the resin foam is more preferably from 20 to 50 kg/m³, and further preferably from 20 to 40 kg/m³.

### (Thickness of Resin Foam)

The thickness of the resin foam is not limited as long as it satisfies the above formula (1), but the thickness is preferably from 25 to 76 mm. By setting the thickness of the resin foam to 25 mm or more, it is possible to impart more appropriate heat insulating properties to the resin foam. Further, by setting the thickness of the resin foam to 76 mm or less, dimensional stability during high-temperature heating is good. In addition, by setting the thickness of the resin foam within the above range, it becomes easier to use the resin foam as a building material. From this viewpoint, the thickness of the resin foam is preferably from 25 to 65 mm, and more preferably from 25 to 55 mm.

### (Polyolefin Resin)

As the polyolefin resin used for the resin foam, a polypropylene resin, a polyethylene resin, and the like is preferred. Among these, a polyethylene resin is more preferred from the viewpoint of flexibility, processability, workability, and the like of the resulting resin foam. Further, a polypropylene resin and a polyethylene resin may be used in combination.

### (Polypropylene Resin)

Examples of the polypropylene resin include homopolypropylene, which is a homopolymer of propylene, copolymers of a propylene and an α-olefin other than propylene, and the like.

Examples of copolymers of propylene and an α-olefin other than propylene include block copolymers, random copolymers, random block copolymers, and the like. Among these, a random copolymer (that is, random polypropylene) is preferred.

Examples of α-olefins other than propylene include ethylene having 2 carbon atoms, α-olefins having about 4 to 10 carbon atoms such as 1-butene, 1-pentene, 1-hexene, 4-methyl-1-pentene, 1-heptene, 1-octene, and the like. Among these, ethylene is preferred from the viewpoint of formability and heat resistance. In the copolymer, these α-olefins can be used alone or in combination of two or more.

Further, the polypropylene resin may be used alone, or two or more types may be used in combination.

Moreover, the copolymer of propylene and an α-olefin other than propylene is preferably obtained by copolymerizing 80% by mass or more and less than 100% by mass of propylene with 20% by mass or less of the α-olefin other than propylene. Here, it is more preferred that propylene is from 90 to 99.5% by mass and the α-olefin other than propylene is from 0.5 to 10% by mass, and further preferred that propylene is from 95 to 99% by mass and the α-olefin other than propylene is from 1 to 5% by mass, with respect to all monomer components constituting the copolymer.

### (Polyethylene Resin)

Examples of the polyethylene resin include low-density polyethylene resins (LDPE, density: less than 0.930 g/cm³), medium-density polyethylene resins (MDPE, density: 0.930 g/cm³ or more and less than 0.942 g/cm³), high-density polyethylene resins (HDPE, density: 0.942 g/cm³ or more), linear low-density polyethylene resins (LLDPE), and the like. Among these, from the viewpoint of flexibility, processability, workability, and the like, a low-density polyethylene resins (LDPE) or a linear low-density polyethylene resin (LLDPE) is preferred, and a low-density polyethylene resin (LDPE) is more preferred.

A linear low-density polyethylene resin is usually a copolymer of ethylene and a small amount of an α-olefin, with ethylene as the main component (preferably 70% by mass or more, and more preferably 90% by mass or more). Here, examples of the α-olefin include α-olefins having preferably from 3 to 12 carbon atoms, more preferably from 4 to 10 carbon atoms, and specific examples include 1-butene, 1-pentene, 1-hexene, 4-methyl-1-pentene, 1-heptene, 1-octene, and the like. In the copolymer, these α-olefins can be used alone or in combination of two or more.

Further, the polyethylene resin may be used alone or in combination of two or more.

As the polyolefin resin, a polyolefin resin other than the resins described above can also be used. Specific examples of such a resin component include an ethylene-vinyl acetate copolymer, an ethylene-acrylic acid copolymer, an ethylene-(meth) alkyl acrylate copolymer, and the like. These resin components may be appropriately added to a resin in which at least one of a polypropylene resin and a polyethylene resin is used, for example.

The resin used for the resin foam may be formed of a polyolefin resin alone. However, as long as the object of the present invention is not hindered, the resin may contain a resin component other than a polyolefin resin. The proportion of the polyolefin resin is, with respect to the total amount of the resin, for example, 70% by mass or more, preferably from 80 to 100% by mass, and more preferably 90 to 100% by mass.

### (Flame Retardant)

The resin foam in the laminated structure according to the first aspect of the present invention preferably further contains a flame retardant. The flame retardant is preferably at least one selected from a phosphorous flame retardant, a halogen flame retardant, an antimony compound, and an inorganic hydrous compound. Such a flame retardant can appropriately improve the flame retardancy of the resin foam. Further, since such a flame retardant does not increase the viscosity of the resin composition too much due to the relationship with the foaming agent described later, the apparent density of the resin foam can be easily adjusted to a suitable range. Therefore, by using the above flame retardant, it is easier to obtain a resin foam having both flame retardancy and heat insulating properties. From such a viewpoint, the flame retardant is more preferably at least one selected from a phosphorus flame retardant, a halogen flame retardant, and an antimony compound, and further preferably at least one selected from a halogen flame retardant and an antimony compound.

### <<Phosphorus Flame Retardant>>

Examples of the phosphorus flame retardant include phosphates, polyphosphates, phosphazene compounds, and phosphorus spiro compounds. Among these, from the viewpoint of a smaller influence on the viscosity of the expandable composition and easier adjustment of the expansion ratio, at least one selected from a phosphate, a polyphosphate, and a phosphorus spiro compound is preferred.

Examples of the phosphate include melamine orthophosphate, piperazine orthophosphate, melamine pyrophosphate, piperazine pyrophosphate, calcium phosphate, magnesium phosphate, and the like.

Examples of the polyphosphate include ammonium polyphosphate, melamine polyphosphate, melamine/melam/melem polyphosphate, and piperazine polyphosphate, and the like.

Further, as the orthophosphate, pyrophosphate, and polyphosphate, in addition to the above, salts of N,N,N′,N′-tetramethyldiaminomethane, ethylenediamine, N,N′-dimethylethylenediamine, N,N′-diethylethylenediamine, N,N-dimethylethylenediamine, N,N-diethylethylenediamine, N,N,N′,N′-tetramethylethylenediamine, N,N,N′,N′-diethylethylenediamine, 1,2-propane diamine, 1,3-propanediamine, tetramethylenediamine, pentamethylenediamine, hexamethylenediamine, 1,7-diaminoheptane, 1,8-diaminooctane, 1,9-diaminononane, 1,10-diaminodecane, trans-2,5-dimethylpiperazine, 1,4-bis(2-aminoethyl)piperazine, 1,4-bis(3-aminopropyl)piperazine, acetoguanamine, benzoguanamine, acrylguanamine, 2,4-diamino-6-nonyl-1,3,5-triazine, 2,4-diamino-6-hydroxy-1,3,5-triazine, 2-amino-4,6-dihydroxy-1,3,5-triazine, 2,4-diamino-6-methoxy-1,3,5-triazine, 2,4-diamino-6-ethoxy-1,3,5-triazine, 2,4-diamino-6-propoxy-1,3,5-triazine, 2,4-diamino-6-isopropoxy-1,3,5-triazine, 2,4-diamino-6-mercapto-1,3,5-triazine, 2-amino-4,6-dimercapto-1,3,5-triazine, ammeline, phthalodiguanamine, melamine cyanurate, melamine pyrophosphate, butylene diguanamine, norbornene diguanamine, methylene diguanamine, ethylene dimelamine, trimethylenedimelamine, tetramethylenedimelamine, hexamethylenedimelamine, 1,3-hexylene dimeramine, and the like can also be used.

Among the above, one or more selected from melamine pyrophosphate, piperazine pyrophosphate, and ammonium polyphosphate are preferred, and it is also preferred to use piperazine pyrophosphate and melamine pyrophosphate in combination.

In addition, as the phosphorus flame retardant, one or more selected from the above-described phosphates and polyphosphates may be mixed with a metal oxide as an intumescent flame retardant.

Examples of the metal oxide used in combination with one or more selected from the phosphates and polyphosphates include zinc oxide, magnesium oxide, calcium oxide, silicon dioxide, titanium oxide, manganese oxide (MnO, MnO₂), iron oxide (FeO, Fe₂O₃, Fe₃O₄), copper oxide, nickel oxide, tin oxide, aluminum oxide, calcium aluminate, and the like. Among these, zinc oxide, magnesium oxide, and calcium oxide are preferred.

When using a mixture of a metal oxide with one or more selected from a phosphate and a polyphosphate, it is preferred to adjust the mass ratios thereof as follows. From the viewpoint of improving flame retardancy, the mass ratio of the one or more selected from a phosphate and a polyphosphate to the metal oxide, [total mass of the phosphate and polyphosphate/mass of the metal oxide] is preferably 4 or more and 100 or less, more preferably 6 or more and 50 or less, and further preferably 10 or more and 35 or less.

Examples of commercially available products of flame retardants containing one or more selected from the above-described phosphates and polyphosphates include “ADK STAB FP-2100J”, “ADK STAB FP-2200S”, and “ADK STAB FP-2500S” manufactured by ADEKA Corporation, “EXOLIT AP422” and “EXOLIT AP462” manufactured by Clariant Japan Co., Ltd., and the like.

The phosphazene compound is an organic compound that has a —P═N— bond in the molecule. As the phosphazene compound, a compound having a 6-membered cyclic phosphazene skeleton having —P═N— is preferred. Examples of the phosphazene compound include “SPB-100” commercially available from Otsuka Chemical Co., Ltd., and the like.

The phosphorus spiro compound is not particularly limited as long as it is a spiro compound having a phosphorus atom. It is noted that a spiro compound is a compound having two cyclic skeletons with one common carbon atom. A spiro compound having a phosphorus atom is a compound in which at least one of the elements constituting those two cyclic skeletons is a phosphorus atom, and it is preferred that each cyclic skeleton has a phosphorus atom. Examples of the phosphorus spiro compound include “Fireguard FCX-210” manufactured by Teijin Limited.

### <<Halogen Flame Retardant>>

The halogen flame retardant stabilizes active OH radicals by a radical trapping effect in the gas phase. Further, during combustion, the active OH radicals and H radicals, which act as combustion promoters, are trapped and stabilized by the hydrogen halide generated from the halogen flame retardant. In addition, since the hydrogen halide generated from the halogen flame retardant during combustion is incombustible, the halogen flame retardant produces a diluting effect and also produces an oxygen shielding effect.

The halogen flame retardant is not particularly limited as long as it contains a halogen in its molecular structure. Examples of the halogen flame retardant include a brominated flame retardant and a chlorinated flame retardant, and a brominated flame retardant is preferred.

The brominated flame retardant is not particularly limited as long as it contains bromine in its molecular structure. Examples of the brominated flame retardant include decabromodiphenyl ether, octabromodiphenyl ether, tetrabromobisphenol A (TBBA), a TBBA epoxy oligomer, a TBBA carbonate oligomer, TBBA bis (dibromopropyl ether), TBBA bis(aryl ether), bis(pentabromophenyl)ethane, 1,2-bis(2,4,6-tribromophenoxy)ethane, 2,4,6-tris(2,4,6-tyrobromophenoxy)-1,3,5-triazine, 2,6- or 2,4-dibromophenol homopolymers, brominated polystyrene, polybrominated styrene, ethylenebistetrabromophthalimide, hexabromocyclododecane, hexabromobenzene, pentabromobenzyl acrylate monomer, pentabromobenzyl acrylate polymer, and the like. Among these, bis(pentabromophenyl)ethane is preferred from the viewpoint of flame retardancy and foaming properties. These brominated flame retardants may be used alone or in combination of two or more.

### <<Antimony Compound>>

Examples of the antimony compound include antimony trioxide, antimony pentoxide, and the like. Among these, antimony trioxide is preferred.

In the case of using a halogen flame retardant, it is preferred to use an antimony compound in combination therewith. The antimony compound can improve the flame retardancy of the resin foam and reduce the content of the halogen flame retardant through a synergistic effect with the halogen flame retardant. When an antimony compound is used, it reacts with a halogen flame retardant during combustion to form an incombustible antimony halide, which has an oxygen shielding effect.

### <<Inorganic Hydrous Compound>>

Examples of the inorganic hydrous compound include magnesium hydroxide, calcium hydroxide, aluminum hydroxide, zinc borate, iron hydroxide, nickel hydroxide, zirconium hydroxide, titanium hydroxide, zinc hydroxide, copper hydroxide, vanadium hydroxide, tin hydroxide, talc, and the like. Among these, at least one selected from aluminum hydroxide, magnesium hydroxide, calcium hydroxide, and talc is preferred, and at least one selected from aluminum hydroxide and magnesium hydroxide is more preferred.

The content of the flame retardant in the resin foam is preferably from 1 to 150 parts by mass with respect to 100 parts by mass of the resin contained in the resin foam. BY setting the content to 1 part by mass or more, flame retardancy can be appropriately imparted to the resin foam. By setting the content to 150 parts by mass or less, the resin foam has good heat insulating properties, processability, mechanical properties, and the like. From these points of view, the content of the flame retardant in the resin foam is, with respect to 100 parts by mass of the resin, more preferably from 2 to 40 parts by mass, further preferably from 3 to 25 parts by mass, and still further preferably from 5 to 15 parts by mass.

One type of the flame retardant may be used alone, or two or more types may be used in combination. For example, when two or more types are used in combination, as described above a combination of a halogen flame retardant and an antimony compound is preferred, and a combination of a brominated flame retardant and an antimony compound is more preferred.

In the case of using a halogen flame retardant and an antimony compound in combination, the ratio of the content of the antimony compound with respect to the content of the halogen flame retardant, (antimony compound/halogen flame retardant), is, from the viewpoint of a synergistic effect with the halogen flame retardant, in terms of mass ratio from 0.1 to 2, preferably from 0.2 to 1.5, and more preferably from 0.3 to 1.0.

### (Foaming Agent)

It is preferred to obtain the resin foam by foaming a resin composition containing the above resin components such as a polyolefin resin. The method for foaming the resin composition may be a chemical foaming method or a physical foaming method. A chemical foaming method is a method in which cells are formed by a gas produced by thermal decomposition of a compound (foaming agent) added to the resin composition. A physical foaming method is a method in which cells are formed by impregnating a resin composition with a low boiling point liquid (foaming agent) and then evaporating the foaming agent. The foaming method is not particularly limited, but from the viewpoint of obtaining a uniform closed-cell resin foam, a chemical foaming method is preferred.

As the foaming agent used for the chemical foaming method, a thermally decomposing foaming agent is used. For example, an organic thermally decomposing foaming agent or an inorganic thermally decomposing foaming agent having a decomposition temperature of about 160 to 270° C. can be used.

Examples of the organic thermally decomposing foaming agent include azo compounds such as azodicarbonamide, azodicarboxylic acid metal salts (such as barium azodicarboxylate), and azobisisobutyronitrile, nitroso compounds such as N,N′-dinitrosopentamethylenetetramine, hydrazine derivatives such as hydrazodicarbonamide, 4,4′-oxybis(benzenesulfonylhydrazide), toluenesulfonyl hydrazide, semicarbazide compounds such as toluenesulfonyl semicarbazide, and the like.

Examples of the inorganic thermally decomposing foaming agent include ammonium carbonate, sodium carbonate, ammonium hydrogen carbonate, sodium hydrogen carbonate, ammonium nitrite, sodium borohydride, anhydrous monosodium citrate, and the like.

Among these, from the viewpoint of obtaining fine cells, economic efficiency, and safety, an organic thermally decomposing foaming agent is preferred, an azo compound or a nitroso compound is more preferred, an azo compound such as azodicarbonamide or azobisisobutyronitrile is further preferred, and azodicarbonamide is still further preferred.

These foaming agents may be used alone or in combination of two or more.

The content of the thermally decomposing foaming agent in the resin composition is, with respect to 100 parts by mass of the resin, preferably from 2 to 40 parts by mass, more preferably from 10 to 35 parts by mass, and further preferably from 15 to 32 parts by mass. When the content of the thermally decomposing foaming agent is within this range, the foaming properties of the resin foam will be adequate and a resin foam having the desired heat insulating properties can be obtained.

### (Other Additives)

The resin foam may further contain additives other than those described above. Specific examples include an antioxidant, a decomposition temperature regulator, a crosslinking aid, a metal damage inhibitor, an antistatic agent, a stabilizer, a filler, a pigment, and the like.

Examples of the antioxidant include a phenol antioxidant, a sulfur antioxidant, a phosphorus antioxidant, and an amine antioxidant. The content of the antioxidant in the resin foam is, with respect to 100 parts by mass of the resin, for example, from 0.1 to 10 parts by mass, and preferably from 0.2 to 3 parts by mass.

Further, examples of the decomposition temperature regulator include zinc oxide, zinc stearate, urea, and the like. The content of the decomposition temperature regulator in the resin foam is, with respect to 100 parts by mass of the resin, for example, from 0.1 to 10 parts by mass, and preferably from 1 to 5 parts by mass.

The resin foam of the present invention may be used as a single resin foam by stacking a plurality of sheet-like resin foams.

### <Metal Sheet>

In the first aspect of the present invention, the laminated structure has a metal sheet, and thus excellent flame retardancy can be imparted to the laminated structure. Further, the metal sheet exhibits a heat shielding effect, and so the heat insulating properties of the laminated structure can be improved. In addition, weather resistance and the like are good. The metal sheet in the laminated structure of the present invention is formed by laminating two or more metal layers.

Examples of the metal constituting the metal layers include zinc, gold, silver, chromium, titanium, iron, aluminum, copper, nickel, tantalum, and an alloy containing these. Examples of the alloy include stainless steel such as SUS, brass, beryllium copper, Inconel, and the like. These metals may be used alone or in combination of two or more.

Among these, aluminum is preferred, and therefore the metal layer is preferably an aluminum layer. By using an aluminum layer, the flexibility of the laminated structure is secured, and the processability and workability of the laminated structure are good. Further, the laminated structure has a lighter weight and is resistant to corrosion.

Of the metal layers in the metal sheet, it is sufficient for at least one metal layer to be an aluminum layer, but it is preferred that all the metal layers in the metal sheet are aluminum layers.

The number of metal layers in the metal sheet is two or more. When the number of metal layers in the metal sheet is one, the laminated structure may have insufficient flame retardancy. Although the principle behind the improvement in flame retardancy when the number of metal layers is two or more is not clear, it is inferred to be as follows. That is, although thin film metal layers are generally thin and tend to tear, even if one metal layer is torn in the event of a fire, the other metal layers prevent the flame from reaching the resin foam, and as a result ignition of the resin foam is delayed.

From this viewpoint, the number of metal layers in the metal sheet is preferably three or more, and more preferably four or more. From the viewpoint of a balance between the flame retardancy of the laminated structure and the manufacturing cost of the metal sheet, the number of metal layers in the metal sheet is preferably eight or less, and more preferably six or less.

The thickness of each metal layer in the metal sheet is preferably 10 μm or more. When the thickness of each metal layer in the metal sheet is 10 μm or more, the flame retardancy of the laminated structure can be further improved. From such a viewpoint, the thickness of each metal layer in the metal sheet is more preferably 14 μm or more, and further preferably 16 μm or more. From the viewpoint of securing the flexibility of the laminated structure, the thickness of each metal layer in the metal sheet is preferably 50 μm or less, more preferably 40 μm or less, and further preferably 30 μm or less.

The total thickness of the metal layers in the metal sheet is not limited as long as it satisfies the above formula (1), but is, for example, from 20 to 250 μm. By setting the total thickness of the metal layers in the metal sheet to 20 μm or more, it is easier for the metal sheet to impart flame retardancy and heat shielding properties to the laminated structure. Further, by setting the total thickness of the metal layers in the metal sheet to 250 μm or less, it is possible to prevent the laminated structure from being thicker than necessary due to the metal sheet.

The total thickness of the metal layers in the metal sheet is preferably from 30 to 150 μm. By setting the total thickness of the metal layers in the metal sheet to 30 μm or more, the strength of the metal sheet is good, problems such as tearing of the metal sheet during construction are less likely to occur, and workability is improved. Further, by setting the total thickness of the metal layers in the metal sheet to 150 μm or less, it is easier to secure the flexibility of the laminated structure as a whole, and the workability of the laminated structure is good. From the viewpoint of workability, and the like, the total thickness of the metal layers in the metal sheet is more preferably from 35 to 100 μm.

The metal sheet preferably has a resin layer provided between adjacent metal layers. Adhesion between the metal layers can be facilitated via the resin layer. Further, the flame retardancy of the laminated structure can be further improved. Although it is not clear why the flame retardancy of the laminated structure can be further improved, the reason is believed to be that by providing a resin layer between the metal layers, even if combustion occurs it is limited, and since the resin layer burns first, the spread of the flame over the entire resin foam is delayed, and so as a result flame retardancy is improved.

From the viewpoint that the metal layers can be adhered to each other via the resin layer by applying heat and pressure, it is preferred to use a thermoplastic resin or a thermosetting resin as the resin constituting the resin layer, and it is more preferred to use a thermoplastic resin. Examples of the resin constituting the resin layer include a polyolefin resin, a polyvinyl chloride resin, a polystyrene resin, polyethylene terephthalate, polyethylene naphthalate, polybutylene terephthalate, polycarbonate, polyamide, and the like. Among these resins, olefin resins are preferred because they are inexpensive and have relatively excellent mechanical properties, a polyethylene resin, an ethylene-vinyl acetate copolymer, or a polypropylene resin is more preferred, and a polyethylene resin is further preferred. As the polyolefin resin used for the resin layer, the same resin as used for the resin foam described above can be used. To strengthen the bonding between the metal layers and the resin layer, the surface of the metal layers may be roughened before adhering the metal layers and the resin layer. Further, to strengthen the bonding between the metal layers and the resin layer, the surface of the resin layer may be subjected to a surface treatment such as a corona treatment, a low-pressure plasma treatment, an atmospheric pressure plasma treatment, a UV-ray treatment, a flame treatment, a silane coupling treatment, and a grafting treatment before adhering the metal layers and the resin layer.

From the viewpoint that the metal layers can be easily adhered to each other via the resin layer, the resin layer may be formed of a hot melt or a pressure-sensitive adhesive. The hot melt constituting the resin layer is not particularly limited, and, for example, a polyolefin hot melt, a polyester hot melt, a polyamide hot melt, a synthetic rubber hot melt, and the like can be used. From the viewpoint that the metal layers can be easily adhered to each other by hot pressing, it is preferred that the resin layer is formed of a film-like hot melt. Further, the pressure-sensitive adhesive constituting the resin layer is not particularly limited, and, for example, an acrylic pressure-sensitive adhesive, a silicone pressure-sensitive adhesive, a urethane pressure-sensitive adhesive, a rubber pressure-sensitive adhesive, and the like can be used.

To prevent the flame retardancy of the laminated structure being insufficient due to insufficient flame retardancy of the resin layer of the metal sheet, it is preferred that the resin layer also have excellent flame retardancy. From such a viewpoint, it is preferred that the resin constituting the resin layer also contain a flame retardant. As the flame retardant used for the resin layer, those used for the resin foam described above can be used. The content of the flame retardant in the resin layer is preferably from 3 to 50% by mass, more preferably from 5 to 40% by mass, and further preferably from 10 to 30% by mass.

The thickness of each resin layer is preferably from 5 to 50 μm. When the thickness of each resin layer is 5 μm or more, the metal layers can be more strongly adhered to each other via the resin layer. When the thickness of each resin layer is 50 μm or less, the flame retardancy of the metal sheet is further improved. From such a viewpoint, the thickness of each resin layer is more preferably from 8 to 30 μm, and further preferably from 12 to 20 μm.

The metal sheet may further include a cloth layer provided between adjacent metal layers. The cloth layer is preferably a flame-retardant cloth layer formed of a flame-retardant fiber. By including a cloth layer, the laminated structure has good mechanical strength, and by forming the cloth layer from a flame-retardant fiber, flame retardancy can be easily imparted.

Examples of the fiber constituting the cloth layer preferably include flame-retardant fibers such as inorganic fibers like glass fiber and carbon fiber, organic fibers like para-aramid fiber, polyarylate fiber, phenolic fiber, and polybutylene isocyanate fiber, and the like. Among these fibers, glass fiber is preferred because it is inexpensive and has excellent flame retardancy. That is, the cloth layer is preferably a glass cloth layer.

The cloth layer is not particularly limited, and may be formed of a fabric having a filament diameter of, for example, about 1 to 10 μm. The fabric may be woven in any weave, such as plain weave, satin weave, or twill weave. Further, the cloth layer may be a knitted fabric, a non-woven fabric, or a net.

The basis weight of the cloth layer is not particularly limited, but it is preferably from 5 to 100 g/m². When the basis weight of the cloth layer is at least the above lower limit, it is much easier to impart incombustibility to the laminated structure. Further, when the basis weight is equal to or less than the above upper limit, appropriate voids can be formed in the cloth layer, and the metal layers can be bonded to each other at those void portions. From the above viewpoints, the basis weight of the cloth layer is more preferably from 10 to 80 g/m², and further preferably from 12 to 50 g/m².

The metal sheet may include a cloth layer between all adjacent metal layers. However, it is sufficient for the metal sheet to include a cloth layer between at least one set of adjacent metal layers among the adjacent metal layers. For example, the cloth layer may be provided between the outermost metal layer and the metal layer adjacent to the outermost metal layer, but the present invention is not particularly limited to this.

Further, the cloth layer is preferably adhered to the adjacent metal layers with an adhesive or the like. When the cloth layer is provided between the outermost metal layer and the metal layer adjacent to the outermost metal layer, for example, the cloth layer may be adhered to the outermost metal layer with an adhesive or the like. When using a metal sheet in which a cloth layer is adhered to a metal layer in this way, it is possible to easily manufacture a metal sheet having a cloth layer. In addition, an example of a metal sheet in which a metal layer and a cloth layer are integrated is an aluminum glass cloth in which an aluminum layer and a glass cloth are integrated.

When a resin layer and a cloth layer are provided between the metal layers, the arrangement order of the layers is preferably metal layer, cloth layer, resin layer, metal layer, and it is preferred that a part of the resin layer is impregnated in the cloth layer.

The metal sheet can be produced, for example, by cold-rolling or hot-rolling a laminated body obtained by laminating a plurality of metal foils to directly bond the metal foils together. The metal sheet can also be produced by applying pressure while heating a laminated body obtained by laminating a plurality of metal foils to directly bond the metal foils together by diffusion bonding.

In addition, the metal sheet can be produced even by applying pressure while heating a laminated body obtained by laminating a plurality of metal foils while sandwiching a sheet of a thermoplastic resin or thermosetting resin between adjacent metal foils to bond the metal foils together via a resin sheet. When a cloth layer is provided, for example, it is preferred to adhere the cloth layer to at least one metal foil in advance, and then produce the metal sheet based on the same method as described above using a plurality of metal foils including the metal foil to which the cloth layer is adhered and a sheet of a thermoplastic resin or thermosetting resin. Moreover, when a resin layer is not provided, the cloth layer may be adhered by fusion bonding or the like. At this time, the metal sheet may be produced by roll-to-roll. For example, the metal foil drawn out from the roller and the resin sheet drawn out from the roll may be laid on each other and the operation repeated.

### <Layer Structure>

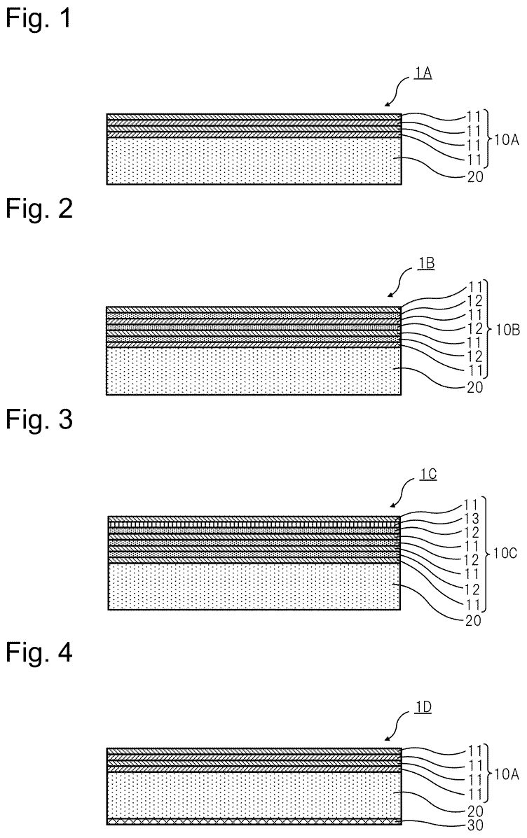

The laminated structure according to the first aspect of the present invention is preferably, as shown in FIG. 1, a laminated structure 1A including a metal sheet 10A formed by laminating two or more metal layers 11 and a resin foam 20. Here, the metal sheet 10A may be laminated directly on the resin foam 20, and is preferably laminated on the resin foam 20 via an adhesion layer (not shown). Although it is difficult to ensure adhesion of the metal sheet 10A to the resin foam 20, by providing the adhesion layer, the metal sheet 10A can be adhered to the resin foam 20 with high adhesive strength. The adhesion layer may be a hot melt film, a pressure-sensitive adhesive, or the resin layer described above.

Further, as shown in FIG. 2, the laminated structure is preferably a laminated structure 1B including a metal sheet 10B formed by laminating two or more metal layers 11 and a resin foam 20, in which the metal sheet 10B includes a resin layer 12 provided between adjacent metal layers 11. Moreover, as described above, the resin foam 20 and the metal sheet 10B are preferably adhered by an adhesion layer such as a resin layer.

In addition, as shown in FIG. 3, the laminated structure is preferably a laminated structure 1C including a metal sheet 10C formed by laminating two or more metal layers 11 and a resin foam 20, in which the metal sheet 10C further includes a cloth layer 13 provided between adjacent metal layers 11. Similarly, the metal layer 11 may be laminated directly on the cloth layer 13, and is preferably laminated via an adhesion layer (not shown). The adhesion layer is preferably formed of a known adhesive. Moreover, as shown in FIG. 3, when the laminated structure has a cloth layer 13, the metal sheet 10C may include a resin layer 12 provided between adjacent metal layers 11.

### <Method for Producing Laminated Structure>

The laminated structure according to the first aspect of the present invention can be obtained by laminating a resin foam on a metal sheet. For example, the laminated structure may be produced by laminating the metal sheet on the resin foam via an adhesion layer. The adhesion layer is preferably, for example, laminated on a metal layer in advance together with a resin layer arranged between the metal layers, and the metal sheet laminated with the adhesion layer is preferably further laminated onto the resin foam.

### [Method for Producing Resin Foam]

Examples of the method for producing the resin foam used for the laminated structure according to the first aspect of the present invention include a method in which a resin composition containing a resin, a thermally decomposing foaming agent, and optional additives such as a flame retardant is extruded by an extruder, and the extruded resin composition is crosslinked and foamed. More specifically, it is preferred to produce the resin foam by the following processes (1) to (3).
Process (1): A process of obtaining a resin composition by feeding a resin, a thermally decomposing foaming agent, and optional additives such as a flame retardant into an extruder, melt-kneading, and then extruding from the extruder.
Process (2): A process of crosslinking by irradiating the resin composition obtained in process (1) with ionizing radiation.
Process (3): A process of foaming the resin composition crosslinked in process (2) to obtain a resin foam.

Examples of the extruder used in this production method include single-screw extruders, twin-screw extruders, and the like. The resin temperature inside the extruder is preferably from 120 to 195° C., and more preferably from 130 to 170° C. Further, the resin composition extruded from the extruder is preferably in the form of a sheet (resin sheet).

In process (2), crosslinking is carried out by irradiating the resin composition obtained in process (1) with ionizing radiation. Examples of the ionizing radiation that can be used in process (2) include a-rays, I3-rays, y-rays, an electron beam, and the like. Among these, an electron beam is preferred. The dose of the ionizing radiation may be any dose as long as the desired degree of crosslinking can be obtained, and is preferably from 1 to 10 Mrad, and more preferably from 3 to 7 Mrad. The progress of the crosslinking by the irradiation of the ionizing radiation is influenced by the make-up of the resin composition, and therefore the irradiation dose may be adjusted while measuring the degree of crosslinking.

In process (3), the crosslinked resin composition may be foamed by heating. The heating temperature during foaming is preferably a temperature equal to or higher than the decomposition temperature of the thermally decomposing foaming agent. The specific heating temperature is usually from 200 to 290° C., and preferably from 220 to 260° C. Further, in process (3), the resin foam may be stretched in either or both of the MD and CD directions after or during foaming.

The method for producing the resin foam used for the laminated structure according to the first aspect of the present invention is not limited to the above production method, and may be produced by another production method.

For example, instead of crosslinking with ionizing radiation, the crosslinking may be carried out by adding an organic peroxide to the resin composition in advance, and heating the resin composition to decompose the organic peroxide. At this time, the resin composition may be foamed while being crosslinked. Further, the resin foam is not required to be a crosslinked product, and in that case process (2) may be omitted. Moreover, the resin foam of the present invention may be used as one resin foam by stacking a plurality of sheet-like resin foams.

### <Usage Methods of Laminated Structure>

The laminated structure according to the first aspect of the present invention can be used in buildings, civil engineering, electronic products, electric products, various types of vehicles such as automobiles, and the like, and is preferably used in buildings.

The laminated structure according to the first aspect of the present invention can be suitably used as a building material in various parts of a building. Specifically, the laminated structure may be used in roofs, walls, floors, ceilings, ducts, and the like, and may also be used in locations other than these.

The laminated structure may be used alone, or may be used by being laminated with other materials. Examples of other materials include materials for constructing a building. Further, for example, when the laminated structure is used by attaching it to a building, it is preferred to attach the resin foam side to the building (that is, another material) and provide the metal sheet side on the external side. That is, the laminated structure preferably constructs a building structure having, in order, metal sheet/resin foam/other material. When the metal sheet is arranged on the external side as in the above building structure, the resin foam is protected by the metal sheet. Therefore, the laminated structure can be used for a long period of time even when the metal sheet side is exposed and subject to the open air, wind, rain, sunlight, and the like. In addition, when a fire breaks out, the metal sheet side arranged on the external side will often come in contact with the flame, but by having the metal sheet, the laminated structure effectively prevents the flame from spreading.

The laminated structure according to the first aspect of the present invention may further include a pressure-sensitive adhesion layer provided on a surface of the resin foam opposite to the surface facing the metal sheet. This allows the laminated structure to adhere to a metal material such as a metal plate via a pressure-sensitive adhesive layer. Examples of the pressure-sensitive adhesion layer include a pressure-sensitive adhesive layer, double-sided tape, and the like.

For example, as shown in FIG. 4, the laminated structure may be a laminated structure 1D including a metal sheet 10A formed by laminating two or more metal layers 11 and a resin foam 20, which further includes a pressure-sensitive adhesion layer 30 provided on the surface of the resin foam 20 opposite to the surface facing the metal sheet 10A side.

The pressure-sensitive adhesive layer is a pressure-sensitive adhesion layer formed of a pressure-sensitive adhesive. The pressure-sensitive adhesive constituting the pressure-sensitive adhesive layer is not particularly limited, and, for example, an acrylic pressure-sensitive adhesive, a silicone pressure-sensitive adhesive, a urethane pressure-sensitive adhesive, a rubber pressure-sensitive adhesive, and the like can be used. The thickness of each pressure-sensitive adhesive layer is preferably, for example, from 1 to 100 μm, and more preferably from 5 to 50 μm.

A pressure-sensitive adhesive double coated sheet includes a base material and a pressure-sensitive adhesive layer provided on each side of the base material. The pressure-sensitive adhesive double coated sheet may be used to adhere one of the pressure-sensitive adhesive layers to the resin foam and the other pressure-sensitive adhesive layer to a metal material.

The base material may be a nonwoven fabric or various resin films. From the viewpoint of incombustibility, flame resistance, and the like, it is preferred that the basis weight of the base material is small, and for example is about 5 to 100 g/m², and preferably about 10 to 50 g/m².

### Second Aspect

### [Metal Sheet]

The metal sheet according to a second aspect of the present invention is a metal sheet formed by laminating two or more metal layers, in which the metal sheet includes a first resin layer provided between adjacent metal layers, each metal layer has a thickness of 50 μm or less, and the metal sheet has a tear strength of 0.5 N or more. As a result, the metal sheet is less likely to tear, and even when adhered to a resin material such as a resin foam and bent, hardly any deformation due to the bending remains in the resin material such as a resin foam.

The thickness of each metal layer in the metal sheet is 50 μm or less. When the thickness of each metal layer in the metal sheet is more than 50 μm, after a laminate structural body obtained by adhering the metal sheet to a resin material such as a resin foam is folded by applying an external force, even after the external force is removed, it may not be possible to resolve the reduction in the thickness of the resin material such as a resin foam caused by the bending of the metal sheet. When the thickness of the resin material such as a resin foam remains reduced in this way, the heat insulating properties of the resin foam might be deteriorated, and the appearance of the resin material such as a resin foam might be worse.

From such a viewpoint, the thickness of each metal layer is preferably 40 μm or less, more preferably 35 μm or less, and further preferably 30 μm or less.

The thickness of each metal layer in the metal sheet is preferably 10 μm or more. When the thickness of each metal layer in the metal sheet is 10 μm or more, it is easier to impart flame retardancy to the laminated structure and the like described later. Further, the tear strength of the metal sheet can be improved. From such a viewpoint, the thickness of each metal layer in the metal sheet is more preferably 14 μm or more, and further preferably 16 μm or more.

The total thickness of the metal layers in the metal sheet according to the second aspect of the present invention is preferably 100 μm or less. When the total thickness of the metal layers in the metal sheet is 100 μm or less, it is easier to resolve the reduction in thickness of the resin foam that occurs when a laminate structural body such as a thermal insulation sheet obtained by adhering the metal sheet to a resin foam or the like is folded.

From such a viewpoint, the total thickness of the metal layers in the metal sheet is more preferably 90 μm or less, further preferably 80 μm or less, and still further preferably 75 μm or less. From the viewpoint of improving the tear strength of the metal sheet, the total thickness of the metal layers in the metal sheet is preferably 25 μm or more, more preferably 30 μm or more, and further preferably 32 μm or more.

The tear strength of the metal sheet according to the second aspect of the present invention is 0.5 N or more. When the tear strength of the metal sheet is less than 0.5 N, the metal sheet may be torn when the metal sheet is attached to the resin foam using the production apparatus. Further, when the tear strength of the metal sheet is 0.5 N or more, when a roll-shaped metal sheet is fed out and conveyed by equipment for the purpose of lamination with another sheet, the metal sheet is less likely to tear even when conveyed under high tension. In addition, when the metal sheet is laminated onto a resin foam and used as a thermal insulator, the metal surface may be laminated in a stretched state. At that time, when the tear strength of the metal sheet is 0.5 N or more, when an object hits the metal sheet during use, the metal sheet is less likely to tear, and moisture resistance and weather resistance are less likely to be harmed. From such a viewpoint, the tear strength of the metal sheet of the present invention is preferably 1.0 N or more, more preferably 2.0 N or more, and further preferably 2.5 N or more. The upper limit of the tear strength range of the metal sheet of the present invention is not particularly limited, but it is usually 8.0 N or less. The tear strength of the metal sheet can be measured by the method described in the Examples below.

The thickness of the metal sheet according to the second aspect of the present invention is preferably 400 μm or less. When the thickness of the metal sheet is 400 μm or less, it is possible to prevent the laminated structure or the like obtained by bonding the metal sheet to a resin foam from becoming thicker than necessary. From such a viewpoint, the thickness of the metal sheet is preferably 350 μm or less, more preferably 320 μm or less, and further preferably 300 μm or less. From the viewpoint of improving the tear strength of the metal sheet, the thickness of the metal sheet is preferably 60 μm or more, more preferably 80 μm or more, and further preferably 100 μm or more. The thickness of the metal sheet is the thickness of the entire metal sheet.

As the metal constituting the metal layers in the metal sheet, the same metals as those constituting the metal layers in the laminated structure of the first aspect can be used. The metal constituting the metal layers in the metal sheet is preferably aluminum, and therefore the metal layer is preferably an aluminum layer. By using an aluminum layer, the flexibility of the laminated structure is secured, and the processability and workability of the laminated structure are good. Further, the laminated structure has a lighter weight and is resistant to corrosion.

Of the metal layers in the metal sheet, it is sufficient for at least one metal layer to be an aluminum layer, but it is preferred that all the metal layers in the metal sheet are aluminum layers.

The number of metal layers in the metal sheet is two or more. When the number of metal layers in the metal sheet is one, the metal sheet may tear when the metal sheet is attached to the resin foam using the production apparatus. Further, when the number of metal layers in the metal sheet is one, the laminated structure may have insufficient flame retardancy. In addition, although the principle behind the improvement in flame retardancy when the number of metal layers is two or more is not clear, it is inferred to be as follows. That is, although thin film metal layers are generally thin and tend to tear, even if one metal layer is torn in the event of a fire, the other metal layers prevent the flame from reaching the resin foam, and as a result ignition of the resin foam is delayed. From this viewpoint, the number of metal layers in the metal sheet is preferably three or more, and more preferably four or more. Further, from the viewpoint that even if adhered to a resin material such as a resin foam and bent, deformation of the resin material such as the resin foam due to that bending does not remain, the number of metal layers in the metal sheet is preferably eight or less, and more preferably six or less.

The metal sheet includes a first resin layer provided between adjacent metal layers. When the metal sheet does not include a first resin layer provided between adjacent metal layers, the tear strength of the metal sheet may be insufficient. Further, when the metal sheet includes a resin layer provided between adjacent metal layers, the flame retardancy of the laminated structure can be further improved. Although it is not clear why the flame retardancy of the laminated structure can be further improved, the reason is believed to be that by providing a resin layer between the metal layers, even if combustion occurs, it is limited, and since the resin layer burns first, the spread of the flame over the entire resin foam is delayed, and so as a result flame retardancy is improved.

Examples of the resin constituting the first resin layer include a polyolefin resin, a polyvinyl chloride resin, a polystyrene resin, polyethylene terephthalate, polyethylene naphthalate, polybutylene terephthalate, polycarbonate, polyamide, and the like. Among these resins, olefin resins are preferred because they are inexpensive and have relatively excellent mechanical properties, a polyethylene resin, an ethylene-vinyl acetate copolymer, or a polypropylene resin is more preferred, and a polyethylene resin is further preferred. To strengthen the bonding between the metal layers and the first resin layer, the surface of the metal layers may be roughened before adhering the metal layers and the first resin layer. Further, to strengthen the bonding between the metal layers and the first resin layer, the surface of the first resin layer may be subjected to a surface treatment such as a corona treatment, a low-pressure plasma treatment, an atmospheric pressure plasma treatment, a UV-ray treatment, a flame treatment, a silane coupling treatment, and a grafting treatment before adhering the metal layers and the first resin layer. As the polyolefin resin used as the resin constituting the first resin layer, for example, the same polyolefin resin as used for the resin foam described later can be used.

From the viewpoint that the metal layers can be easily adhered to each other via the first resin layer, the first resin layer may be formed of a hot melt or a pressure-sensitive adhesive. The hot melt constituting the first resin layer is not particularly limited, and, for example, a polyolefin hot melt, a polyester hot melt, a polyamide hot melt, a synthetic rubber hot melt, and the like can be used. From the viewpoint that the metal layers can be easily adhered to each other by hot pressing, it is preferred that the first resin layer is formed of a film-like hot melt. Further, the pressure-sensitive adhesive constituting the first resin layer is not particularly limited, and, for example, an acrylic pressure-sensitive adhesive, a silicone pressure-sensitive adhesive, a urethane pressure-sensitive adhesive, a rubber pressure-sensitive adhesive, and the like can be used.

To prevent the flame retardancy of the laminated structure being insufficient due to insufficient flame retardancy of the first resin layer of the metal sheet, it is preferred that the first resin layer also have excellent flame retardancy. From such a viewpoint, it is preferred that the resin constituting the first resin layer also contain a flame retardant. As the flame retardant used for the resin layer, those used for the resin foam described later can be used. The content of the flame retardant in the resin layer is preferably from 3 to 50% by mass, more preferably from 5 to 40% by mass, and further preferably from 10 to 30% by mass.

The thickness of the first resin layer is preferably from 5 to 50 μm. When the thickness of the first resin layer is 5 μm or more, the metal layers can be more strongly adhered to each other via the first resin layer, and the tear strength of the metal sheet can be improved. When the thickness of the first resin layer is 50 μm or less, the thickness of the metal sheet can be reduced. From such a viewpoint, the thickness of the first resin layer is more preferably from 8 to 30 μm, and further preferably from 12 to 20 μm.

The metal sheet according to the second aspect of the present invention may include a second resin layer provided on one surface of the metal sheet. It is preferred that the second resin layer is laminated on the metal sheet, for example. When the second resin layer is provided, because the laminated structure can be produced by adhering the metal sheet and the resin foam via the second resin layer, production of the laminated structure is facilitated. As the resin constituting the second resin layer, the same resins as those constituting the first resin layer described above can be used. Further, the thickness of the second resin layer can be the same as the thickness range of the first resin layer described above.

The metal sheet may further include a reinforcement cloth layer provided between adjacent metal layers.

The reinforcing fiber that constitutes the reinforcement cloth layer is preferably a flame-retardant fiber. Examples of the reinforcing fibers constituting the reinforcement cloth layer include inorganic fiber such as glass fiber and carbon fiber, organic fibers such as wholly aromatic polyamide fiber, wholly aromatic polyester fiber, ultra-high molecular weight fiber, high-strength vinylon fiber, and high-strength acrylic fiber. Among these fibers, glass fiber is preferred because it is inexpensive and has relatively good mechanical properties. That is, the reinforcement cloth layer is preferably a glass cloth layer.

By including the reinforcement cloth layer, the tear strength of the metal sheet can be further improved. The reinforcement cloth layer is not particularly limited, and may be formed of glass fiber having a filament diameter of, for example, about 1 to 10 μm. The reinforcement cloth layer may be woven in any weave, such as plain weave, satin weave, or twill weave. Further, the reinforcement cloth layer may be a knitted fabric, a non-woven fabric, or a net.

The basis weight of the reinforcement cloth layer is not particularly limited, but it is preferably from 5 to 100 g/m². When the basis weight of the reinforcement cloth layer is at least the above lower limit, it is much easier to impart incombustibility to the laminated structure. Further, when the basis weight is equal to or less than the above upper limit, appropriate voids can be formed in the reinforcement cloth layer, the metal layers can be bonded to each other at those void portions, and the resin can be impregnated more easily. From the above viewpoints, the basis weight of the reinforcement cloth layer is more preferably from 10 to 80 g/m², and further preferably from 12 to 50 g/m².

The metal sheet may include a reinforcement cloth layer between all adjacent metal layers. However, it is sufficient for the metal sheet to include a reinforcement cloth layer between at least one set of adjacent metal layers among the adjacent metal layers. For example, at least one reinforcement cloth layer may be provided between the outermost metal layer and the metal layer adjacent to the outermost metal layer, but the present invention is not particularly limited to this.

Further, the reinforcement cloth layer is preferably adhered to the adjacent metal layers with an adhesive or the like. When the reinforcement cloth layer is provided between the outermost metal layer and the metal layer adjacent to the outermost metal layer, for example, the reinforcement cloth layer may be adhered to the outermost metal layer with an adhesive or the like. When using a metal sheet in which a reinforcement cloth layer is adhered to a metal layer in this way, it is possible to easily manufacture a metal sheet having a cloth layer. In addition, an example of a metal sheet in which a metal layer and a reinforcement cloth layer are integrated is an aluminum glass cloth in which an aluminum layer and a glass cloth are integrated.

When a reinforcement cloth layer is provided, the arrangement order of the layers is preferably metal layer, reinforcement cloth layer, resin layer, and metal layer, and it is preferred that a part of the resin layer is impregnated in the reinforcement cloth layer.

### <Layer Structure>

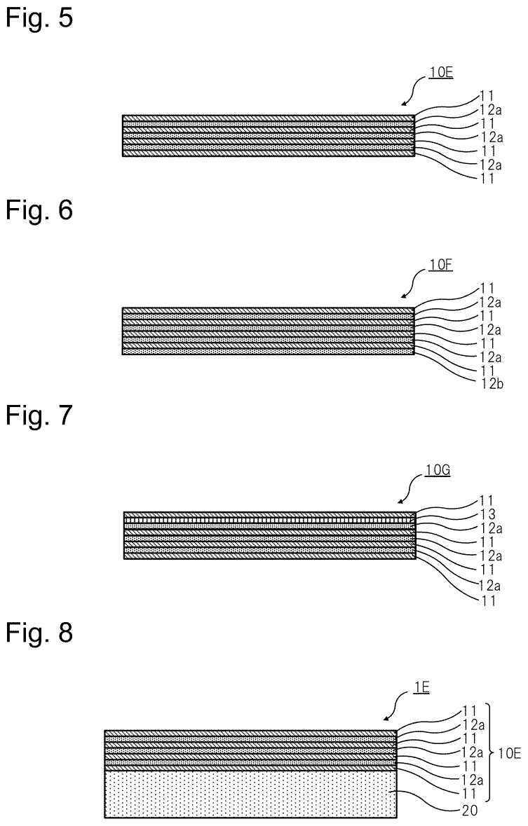

The metal sheet according to the second aspect of the present invention may be, as shown in FIG. 5, a metal sheet 10E formed by laminating two or more metal layers 11, which includes a first resin layer 12a provided between adjacent metal layers 11. Further, as shown in FIG. 6, the metal sheet may be a metal sheet 10F formed by laminating two or more metal layers 11, which includes a first resin layer 12a provided between adjacent metal layers 11 and further includes a second resin layer 12b provided on one surface of the metal sheet. Moreover, as shown in FIG. 7, the metal sheet may be a metal sheet 10G formed by laminating two or more metal layers 11, which includes a first resin layer 12a provided between adjacent metal layers 11 and further includes a reinforcement cloth layer 13 provided between adjacent metal layers 11.

### <Method for Producing Metal Sheet>

The metal sheet according to the second aspect of the present invention can be produced by applying pressure while heating a laminated body obtained by laminating a plurality of metal foils while sandwiching a sheet of a thermoplastic resin or thermosetting resin between adjacent metal foils to bond the metal foils together via a resin layer. At this time, the metal sheet may be produced by roll-to-roll. For example, the metal foil drawn out from the roller and the resin sheet drawn out from the roll may be stacked on each other and the operation repeated.

When a reinforcement cloth layer is provided, for example, it is preferred to adhere the reinforcement cloth layer to at least one metal foil in advance, and then produce the metal sheet based on the same method as described above using a plurality of metal foils including the metal foil to which the reinforcement cloth layer is adhered and a sheet of a thermoplastic resin or thermosetting resin.

The metal sheet according to the second aspect of the present invention may be laminated on a resin material such as a resin foam and used as part of a laminated structure. This allows various types of performance, such as heat insulating properties, mechanical strength, moisture resistance, and weather resistance, of the resin material to be improved. Further, flame retardancy can also be imparted to the laminated structure. Hereinafter, a more detailed description of the structural configuration will be given in the case where the resin material is a resin foam and the laminated structure is a thermal insulation sheet.

### [Laminated Structure]

The laminated structure according to the second aspect of the present invention includes the metal sheet according to the second aspect of the present invention and a resin foam adhered to one surface of the metal sheet. This allows the heat insulating properties of the laminated structure to be improved as well as the mechanical strength, moisture resistance, and weather resistance of the laminated structure to be improved. Moreover, flame retardancy and fire resistant property can be imparted to the laminated structure.

Further, the laminated structure according to the second aspect of the present invention includes a metal sheet formed by laminating two or more metal layers, and a resin foam, wherein a total thickness of the metal layers in the metal sheet, Ta (μm), and a thickness of the resin foam, Tb (mm), satisfy the relationship of the following formula (1).

$$Ta / Tb \geq 0.7 \qquad ( 1 )$$

The laminated structure having the above structural configuration has excellent flame retardancy.

(Ratio (Ta/Tb) of total thickness of metal layers, Ta (μm), to thickness of resin foam, Tb (mm))

As shown by the above formula (1), the ratio (Ta/Tb) of the total thickness of the metal layers, Ta (μm), to the thickness of the resin foam, Tb (mm), is 0.70 or more. When the ratio (Ta/Tb) of the total thickness of the metal layers, Ta (μm), to the thickness of the resin foam, Tb (mm), is less than 0.70, the flame retardancy of the laminated structure may be insufficient. From such a viewpoint, the ratio (Ta/Tb) of the total thickness of the metal layers, Ta (μm), to the thickness of the resin foam, Tb (mm), is preferably 0.80 or more, more preferably 1.00 or more, further preferably 1.20 or more, and still further preferably 1.40 or more. On the other hand, from the viewpoint of securing the flexibility of the laminated structure and heat insulating properties, the ratio (Ta/Tb) of the total thickness of the metal layers, Ta (μm), to the thickness of the resin foam, Tb (mm), is preferably 10.00 or less, more preferably 8.00 or less, further preferably 5.00 or less, and still further preferably 2.00 or less.

The structural configuration of the laminated structure will now be described in more detail.

### <Metal Sheet>

As described above, the metal sheet in the laminated structure according to the second aspect of the present invention is the metal sheet according to the second aspect of the present invention. The metal sheet according to the second aspect of the present invention has already been described, and so a description of the metal sheet is omitted.

### <Resin Foam>

The resin contained in the resin foam of the laminated structure according to the second aspect of the present invention is preferably a thermoplastic resin. By using a thermoplastic resin as the resin contained in the resin foam, the processability and workability or the like, of the resin foam are good.

The resin contained in the resin foam is not particularly limited, but it is preferred to use a resin that can be used for a resin foam. Specific examples include polyvinyl chloride resins, silicone resins, acrylic resins, polyurethane resins, polyolefin resins, elastomers, and styrene resins. The elastomer may be a thermoplastic elastomer or a rubber component other than a thermoplastic elastomer. Among these, a polyolefin resin is preferred from the viewpoint of the processability and formability of the resin foam.

### (Degree of Crosslinking)

The resin foam is preferably obtained by crosslinking and foaming a resin composition, and more preferably by crosslinking and foaming a resin composition with an electron beam. The degree of crosslinking represented by the gel fraction of the resin foam obtained by crosslinking and foaming the resin composition is the same as the degree of crosslinking of the resin foam in the laminated structure according to the first aspect, and so a description of the degree of crosslinking is omitted.

### (Apparent Density)

The apparent density of the resin foam is preferably from 10 to 100 kg/m³. The apparent density of the resin foam is the same as the apparent density of the resin foam of the laminated structure according to the first aspect, and so a description of the apparent density is omitted.

### (Thickness of Resin Foam)

The thickness of the resin foam is preferably from 5 to 76 mm. By setting the thickness of the resin foam to 5 mm or more, it is possible to impart more appropriate heat insulating properties to the resin foam. Further, by setting the thickness of the resin foam to 76 mm or less, dimensional stability during high-temperature heating is good. In addition, by setting the thickness of the resin foam within the above range, it becomes easier to use the resin foam as a building material. From this viewpoint, the thickness of the resin foam is preferably from 7 to 65 mm, and more preferably from 8 to 55 mm.

### (Polyolefin Resin)

As the polyolefin resin used for the resin foam, a polypropylene resin, a polyethylene resin, and the like is preferred. Among these, a polyethylene resin is more preferred from the viewpoint of flexibility, processability, workability, and the like of the resulting resin foam. Further, a polypropylene resin and a polyethylene resin may be used in combination.

### (Polypropylene Resin)

The polypropylene resin used for the resin foam is the same as the polypropylene resin used for the resin foam in the laminated structure according to the first aspect, and so a description of the polypropylene resin is omitted.

### (Polyethylene Resin)

The polyethylene resin used for the resin foam is the same as the polyethylene resin used for the resin foam in the laminated structure according to the first aspect, and so a description of the polyethylene resin is omitted.

### (Flame Retardant)

The resin foam in the laminated structure according to the second aspect of the present invention preferably further contains a flame retardant. The flame retardant used for the resin foam is the same as the flame retardant used for the resin foam in the laminated structure according to the first aspect, and so a description of the flame retardant is omitted.

### (Foaming Agent)

It is preferred to obtain the resin foam by foaming a resin composition containing the above resin components such as a polyolefin resin. The method for foaming the resin composition may be a chemical foaming method or a physical foaming method. A chemical foaming method is a method in which cells are formed by a gas produced by thermal decomposition of a compound (foaming agent) added to the resin composition. A physical foaming method is a method in which cells are formed by impregnating a resin composition with a low boiling point liquid (foaming agent) and then evaporating the foaming agent. The foaming method is not particularly limited, but from the viewpoint of obtaining a uniform closed-cell resin foam, a chemical foaming method is preferred.

As the foaming agent used for the chemical foaming method, a thermally decomposing foaming agent is used. For example, an organic thermally decomposing foaming agent or an inorganic thermally decomposing foaming agent having a decomposition temperature of about 160 to 270° C. can be used. The foaming agent used for producing the resin foam is the same as the foaming agent used for producing the resin foam in the laminated structure according to the first aspect, and so a description of the foaming agent is omitted.

### (Other Additives)

The resin foam may further contain additives other than those described above. These additives other than those described above that are used for the resin foam are the same as the other additives used for the resin foam in the laminated structure according to the first aspect, and so a description of the additives other than those described above is omitted.

The resin foam in the laminated structure according to the second aspect of the present invention may be used as a single resin foam by stacking a plurality of sheet-like resin foams.

### <Layer Structure>

The laminated structure according to the second aspect of the present invention is preferably, as shown in FIG. 8, a laminated structure 1E including a metal sheet 10E formed by laminating two or more metal layers 11 and a resin foam 20. Here, the metal sheet 10E may be laminated directly on the resin foam 20, and is preferably laminated on the resin foam 20 via an adhesion layer (not shown). Although it is difficult to ensure adhesion of the metal sheet 10E to the resin foam 20, by providing the adhesion layer, the metal sheet 10E can be adhered to the resin foam 20 with high adhesive strength. It is sufficient for the adhesion layer to be a thermoplastic resin, a thermosetting resin, a hot melt film, or a pressure-sensitive adhesive, and is preferably the second resin layer described above.

### <Method for Producing Laminated Structure>

The laminated structure according to the second aspect of the present invention can be obtained by laminating a resin foam on a metal sheet. For example, the laminated structure may be produced by laminating the metal sheet on the resin foam via an adhesion layer of the second resin layer or the like.

### [Method for Producing Resin Foam]

The method for producing the resin foam used for the laminated structure according to the second aspect of the present invention is the same as the method for producing the resin foam used for the laminated structure according to the first aspect of the present invention, and so a description of the method for producing the resin foam used for the laminated structure according to the second aspect of the present invention is omitted.

### <Usage Methods of Laminated Structure>

The usage methods of the laminated structure according to the second aspect of the present invention are the same as the usage methods of the laminated structure according to the first aspect of the present invention, and so a description of the usage methods of the laminated structure according to the second aspect of the present invention is omitted.

The laminated structure according to the second aspect of the present invention may further include a pressure-sensitive adhesion layer provided on a surface of the resin foam opposite to the surface facing the metal sheet. This allows the laminated structure to adhere to a metal material such as a metal plate via the pressure-sensitive adhesion layer. Examples of the pressure-sensitive adhesion layer include a pressure-sensitive adhesive layer, double-sided tape, and the like.

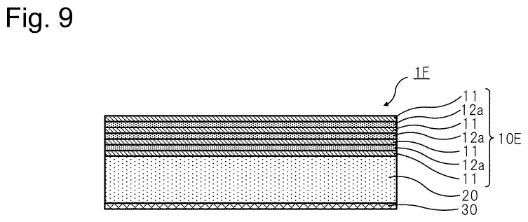

For example, as shown in FIG. 9, the laminated structure may be a laminated structure 1F including a metal sheet 10E and a resin foam 20, which further includes a pressure-sensitive adhesion layer 30 provided on the surface of the resin foam 20 opposite to the surface facing the metal sheet 10E side.

The pressure-sensitive adhesive layer is a pressure-sensitive adhesion layer formed of a pressure-sensitive adhesive. The pressure-sensitive adhesive constituting the pressure-sensitive adhesive layer is not particularly limited, and, for example, an acrylic pressure-sensitive adhesive, a urethane pressure-sensitive adhesive, a rubber pressure-sensitive adhesive, and the like can be used. The thickness of each pressure-sensitive adhesive layer is preferably, for example, from 1 to 100 μm, and more preferably from 5 to 50 μm.

The pressure-sensitive adhesive double coated sheet includes a base material and a pressure-sensitive adhesive layer provided on each side of the base material. The pressure-sensitive adhesive double coated sheet may be used to adhere one of the pressure-sensitive adhesive layers to the resin foam and the other pressure-sensitive adhesive layer to a metal material.

The base material may be a nonwoven fabric or various resin films. From the viewpoint of incombustibility, flame resistance, and the like, it is preferred that the basis weight of the base material is small, and for example is about 5 to 100 g/m², and preferably about 10 to 50 g/m².

### Third Aspect

A third aspect of the present invention provides the following [1] to [11].

[1] A metal sheet formed by laminating two or more metal layers, wherein the metal sheet includes a first resin layer provided between adjacent metal layers, the thickness of each metal layer is 50 μm or less, and the metal sheet has a tear strength of 0.5 N or more.

[2] The metal sheet according to the above [1], wherein each metal layer has a thickness of 10 μm or more.

[3] The metal sheet according to the above [1] or [2], wherein the resin constituting the first resin layer contains a polyolefin resin.

[4] The metal sheet according to any one of the above [1] to [3], including a second resin layer provided on one surface.

[5] The metal sheet according to the above [4], wherein the resin constituting the second resin layer contains a polyolefin resin.

[6] The metal sheet according to any one of the above [1] to [5], further including a reinforcement cloth layer provided between adjacent metal layers.

[7] The metal sheet according to any one of the above [1] to [6], wherein at least one metal layer is an aluminum layer.

[8] The metal sheet according to any one of the above [1] to [7], wherein a total thickness of the metal layers is 100 μm or less.

[9] The metal sheet according to any one of the above [1] to [8], wherein the metal sheet has a thickness of 400 μm or less.

[10] A laminated structure including the metal sheet according to any one of the above [1] to [9], and a resin foam adhered to one surface of the metal sheet.

[11] The laminated structure according to the above [10], further including a pressure-sensitive adhesion layer provided on a surface of the resin foam opposite to the surface facing the metal sheet.

According to the third aspect of the present invention, a metal sheet that is less likely to tear, and in which even when adhered to a resin material such as a resin foam and bent, hardly any deformation due to the bending remains in the resin material such as a foam, and a laminated structure that includes the metal sheet, can be provided.

The laminated structure according to the third aspect of the present invention may or may not satisfy the relationship of the above formula (1). Other than that, the metal sheet according to the third invention of the present invention is the same as the metal sheet according to the second aspect of the present invention, and the laminated structure according to the third aspect of the present invention is the same as the laminated structure according to the second aspect of the present invention. Therefore, a description of the metal sheet according to the third aspect of the present invention and the laminated structure according to the third aspect of the present invention will be omitted.

### EXAMPLES

The present invention will be described in more detail below with reference to examples, but the present invention is not limited by these examples.

### First Examples

The method for measuring the various physical properties and the method for evaluating the resin foam were as follows.

### (1) Degree of Crosslinking

A test piece of about 100 mg was taken from the resin foam, and a mass A (mg) of the test piece was accurately weighed. Next, the test piece was dipped in 30 cm³ of 120° C. xylene, left for 24 hours, and then filtered through a 200-mesh wire mesh. The insoluble matter on the wire mesh was collected, vacuum dried, and a mass B (mg) of the insoluble matter was accurately weighed. From the obtained values, the degree of crosslinking (% by mass) was calculated based on the following formula.

$$Degree of crosslinking ( \% by mass ) = 100 \times ( B / A )$$

### (2) Density

The density (apparent density) of the resin foam was measured according to JIS K7222.

### (3) Thickness of Metal Layers and Resin Foam

Thickness was measured with a dial gauge.

### (4) Flame Spread Index (FSI) and Smoke-Developed Index (SDI)

The flame spread index (FSI) and smoke-developed index (SDI) of the laminated structures of the examples and comparative examples were evaluated by the Steiner Tunnel Test in accordance with ASTM E84, and judged according to the following criteria.

### (i) Flame Spread Index (FSI)

Double circle: 0 to 25
Circle: 26 to 30
Cross: 31 or more

### (ii) Smoke-Developed Index (SDI)

Double circle: 0 to 50
Circle: 51 to 300
Cross: 301 or more
   (iii) Overall Judgment
Double circle: Both FSI and SDI judgments are double circles
Circle: Both FSI and SDI judgments are a circle, or one of FSI and SDI is a circle and the other of FSI and SDI is a double circle
Cross: At least one judgment of FSI and SDI is a cross

### Example 1

### (Production of Resin Foam)

In each example and comparative example, each component shown in the resin foam column of Table 1 was fed into a single screw extruder, melted and kneaded at 120° C., and extruded to form a 2 mm thick resin sheet (resin composition). The resin sheet was crosslinked by irradiating both surfaces of the resin sheet with an electron beam at an acceleration voltage of 500 kV and an irradiation dose of 5.5 Mrad. Then, the crosslinked resin sheet was heated in a hot air oven at 240° C. for 3 minutes. The heat caused the resin sheet to foam, whereby a resin foam having a thickness of 5 mm was obtained. The surfaces of the 5 mm resin foams were heated to 80° C., and successively laminated to obtain a 25 mm resin foam.

### (Production of Metal Sheet)

One sheet of an aluminum glass cloth in which 18 μm aluminum foil and a glass cloth having a basis weight of 14 g/m² were adhered, three sheets of 18 μm aluminum foil, and four flame-retardant polyethylene sheets (trade name “FP-PF”, manufactured by Asahi Sangyo Co., Ltd., 15 μm thick) (flame-retardant PE) were prepared. The glass cloth that was used was a glass net.

The sheets of flame-retardant PE and aluminum foil were alternately stacked on the surface on the glass cloth side of the aluminum glass cloth to obtain a laminated body having a layer structure of Al foil/glass cloth/flame-retardant PE/Al foil/flame-retardant PE/Al foil/flame-retardant PE/Al foil/flame-retardant PE. This laminated body was stuck together by heating at a temperature of 130° C. to produce a metal sheet having four metal layers, in which the thickness of each metal layer was 18 μm and the total metal layer thickness was 72 μm.

### (Production of Laminated Structure)

The metal sheet and the resin foam were stacked so that the flame-retardant polyethylene sheet of the metal sheet and the resin foam were in contact, and then the metal sheet and the resin foam were laminated together by heating to 120° C. from the metal sheet side to obtain a laminated structure.

### Examples 2 to 7 and Comparative Examples 1 and 2

The number of metal layers in the metal sheet, the thickness of one metal layer, and the total thickness of the metal layers were changed as shown in Table 1 by changing the thickness and number of layers of the aluminum foil used for the metal sheet. In addition, the thickness of the resin foam was changed as shown in Table 1 by changing the number of 5 mm-thick resin foams to be laminated. Other than that, the laminated structures of Examples 2 to 7 and Comparative Examples 1 and 2 were produced in the same manner as the laminated structure of Example 1. However, in Comparative Examples 1 and 2, a structure in which flame-retardant PE was laminated on one surface of the aluminum foil was used.

### Comparative Example 3

Comparative Example 3 was carried out in the same manner as in Example 1, except that a metal sheet was not provided.

The evaluation results of the laminated structures of each of the examples and comparative examples are shown in Table 1.

TABLE 1

| | | | Example | | | | | |
|---|---|---|---|---|---|---|---|---|
| | | | 1 | 2 | 3 | 4 | 5 | 6 |
| Metal sheet | Metal layer material | | aluminum | aluminum | aluminum | aluminum | aluminum | aluminum |
| | Number of metal layers | | 4 | 4 | 2 | 2 | 2 | 2 |
| | Thickness of one | | 18 | 18 | 25 | 25 | 18 | 18 |
| | metal layer (μm) | | | | | | | |
| | Total thickness of metal | | 72 | 72 | 50 | 50 | 36 | 36 |
| | layers (Ta) (μm) | | | | | | | |
| Resin foam | Blend | LDPE | 100 parts | 100 parts | 100 parts | 100 parts | 100 parts | 100 parts |
| | | Brominated | 6 parts | 6 parts | 6 parts | 6 parts | 6 parts | 6 parts |
| | | fire retardant | | | | | | |
| | | Antimony | 3 parts | 3 parts | 3 parts | 3 parts | 3 parts | 3 parts |
| | | trioxide | | | | | | |
| | | Zinc stearate | 2.2 parts | 2.2 parts | 2.2 parts | 2.2 parts | 2.2 parts | 2.2 parts |
| | | Antioxidant | 0.4 parts | 0.4 parts | 0.4 parts | 0.4 parts | 0.4 parts | 0.4 parts |
| | | ADCA | 30 parts | 30 parts | 30 parts | 30 parts | 30 parts | 30 parts |
| | Density (kg/m³) | | 25 | 25 | 25 | 25 | 25 | 25 |
| | Thickness (Tb) (mm) | | 40 | 50 | 40 | 50 | 25 | 35 |
| | Degree of crosslinking (%) | | 28 | 28 | 28 | 28 | 28 | 28 |
| Thickness ratio (Ta/Tb) | | | 1.80 | 1.44 | 1.25 | 1.00 | 1.44 | 1.03 |
| Fire-retardant | Flame spread | Evaluation | 20 | 20 | 30 | 30 | 5 | 5 |
| ASTM E84 | index (FSI) | Judgement | ⊚ | ⊚ | ◯ | ◯ | ⊚ | ⊚ |
| | Smoke-developed | Evaluation | 45 | 15 | 120 | 25 | 140 | 125 |
| | index (SDI) | Judgement | ⊚ | ⊚ | ◯ | ⊚ | ◯ | ◯ |

| | | | | | | |
|---|---|---|---|---|---|---|
| Overall judgement | ⊚ | ⊚ | ◯ | ◯ | ◯ | ◯ |

| | | | Example | Comparative Example | | |
|---|---|---|---|---|---|---|
| | | | 7 | 1 | 2 | 3 |
| Metal sheet | Metal layer material | | aluminum | aluminum | aluminum | — |
| | Number of metal layers | | 2 | 1 | 1 | — |
| | Thickness of one | | 18 | 18 | 18 | — |
| | metal layer (μm) | | | | | |
| | Total thickness of metal | | 36 | 18 | 18 | — |
| | layers (Ta) (μm) | | | | | |
| Resin foam | Blend | LDPE | 100 parts | 100 parts | 100 parts | 100 parts |
| | | Brominated | 6 parts | 6 parts | 6 parts | 6 parts |
| | | fire retardant | | | | |
| | | Antimony | 3 parts | 3 parts | 3 parts | 3 parts |
| | | trioxide | | | | |
| | | Zinc stearate | 2.2 parts | 2.2 parts | 2.2 parts | 2.2 parts |
| | | Antioxidant | 0.4 parts | 0.4 parts | 0.4 parts | 0.4 parts |
| | | ADCA | 30 parts | 30 parts | 30 parts | 30 parts |
| | Density (kg/m³) | | 25 | 25 | 25 | 25 |
| | Thickness (Tb) (mm) | | 40 | 30 | 40 | 40 |
| | Degree of crosslinking (%) | | 28 | 28 | 28 | 28 |
| Thickness ratio (Ta/Tb) | | | 0.90 | 0.60 | 0.45 | — |
| Fire-retardant | Flame spread | Evaluation | 10 | 40 | 75 | 265 |
| ASTM E84 | index (FSI) | Judgement | ⊚ | X | X | X |
| | Smoke-developed | Evaluation | 300 | 130 | 450 | 300 |
| | index (SDI) | Judgement | ◯ | ◯ | X | ◯ |

| | | | | |
|---|---|---|---|---|
| Overall judgement | ◯ | X | X | X |

The details of each component in Table 1 are as follows.
LDPE: Manufactured by Ube-Maruzen Polyethylene Co., Ltd., trade name “522N”
Brominated flame retardant: 1,2-bis(2,3,4,5,6-pentabromophenyl)ethane, manufactured by Albemarle Japan, trade name “SAYTEX8010”
Antimony trioxide: Nihon Seiko Co., Ltd., trade name “PATOX-M”
Zinc stearate: Manufactured by Sakai Chemical Industry Co., Ltd., trade name “SZ-2000”
Antioxidant: Manufactured by BASF Japan Ltd., trade name “Irganox 1010”
ADCA: Azodicarbonamide, foaming agent

The laminated structure of each of the above examples includes a metal sheet formed by laminating two or more metal layers, and a resin foam, wherein a total thickness of the metal layers in the metal sheet, Ta (μm), and a thickness of the resin foam, Tb (mm), satisfy the relationship of the above formula (1). Therefore, these laminated structures had excellent flame retardancy.

On the other hand, in the laminated structures of Comparative Examples 1 and 2, the metal sheet is formed of one metal layer, and the total thickness of the metal layers in the metal sheet, Ta (μm), and the thickness of the resin foam, Tb (mm), does not satisfy the relationship of the above formula (1), and thus flame retardancy was insufficient. Moreover, since the laminated structure of Comparative Example 3 does not include a metal sheet, flame retardancy was insufficient.

### Second Examples

The method for measuring the various physical properties and the method for evaluating the resin foam were as follows.

### (1) Degree of Crosslinking

The degree of crosslinking was measured in the same manner as in the first examples.

### (2) Density

The density (apparent density) of the resin foam was measured in the same manner as in the first examples.

### (3) Thickness of Metal Layer, Metal Sheet, and Resin Foam

Thickness was measured by the same manner as in the first examples.

### (4) Tear Strength

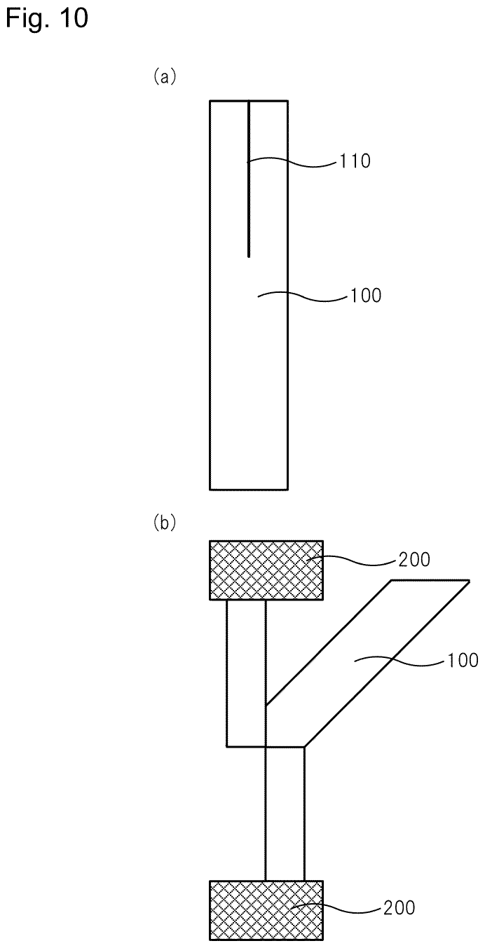

The method for measuring the tear strength of the metal sheet will be described with reference to FIG. 10.
(i) A test piece 100 having a length of 100 mm and a width of 20 mm was produced from the metal sheet.
(ii) As shown in FIG. 10(a), a cut 110 having a length of 40 mm was formed in the test piece 100 perpendicularly from the center of the short side.
(iii) As shown in FIG. 10(b), with the cut set so as to be vertical, each short side of the test piece 100 divided into two by the cut was attached to two opposing clamps 200 of a tensile tester (“Tensilon Universal Material Testing Instrument”, manufactured by A&D Company, Ltd.).
(iv) The test piece 100 was pulled by the tensile tester at a rate of 100 mm/min to tear the test piece 100 from the cut 110.
(v) The average value of the load (N) detected by a load cell from the end of the cut 110 until the test piece 100 was torn by the tensile tester was taken as the tear strength of the metal sheet. The tear strength was judged according to the following criteria.
Double circle: Tear strength of 2.0 N or more
Circle: Tear strength of 0.5 N or more and less than 2.0 N
Cross: Tear strength of less than 0.5 N

### (5) Reduction in Thickness of Resin Foam Due to Buckling of Laminated Structure

(i) A square test piece was produced by cutting the laminated structure into a size of 200 mm×200 mm.
(ii) Two opposite sides of the test piece were held with both hands, and the test piece was slowly folded so that the metal sheet surface faced inward until the metal sheet buckled.
(iii) After folding the test piece until the metal sheet buckled, the test piece was returned to its original flat state.
(iv) The reduction in thickness of the resin foam due to the buckling was visually observed by looking at the test piece from the side, and evaluated according to the following criteria.
Circle: Reduction in the thickness of the resin foam of 1.2 mm or less
Cross: Reduction in the thickness of the resin foam of more than 1.2 mm

### Example 8

### (Production of Metal Sheet)

Three sheets of 12 μm aluminum foil (Al foil) and three flame-retardant polyethylene sheets (trade name “FP-PF”, manufactured by Asahi Sangyo Co., Ltd.) (PE) were alternately stacked to produce a laminated body. The layer structure of the laminated body was Al foil/PE/Al foil/PE/Al foil/PE. This laminated body was stuck together by heating at a temperature of 130° C. to produce a metal sheet having three metal layers, in which the thickness of each metal layer was 12 μm and which included a first resin layer provided between adjacent metal layers and a second resin layer arranged on one surface of the metal sheet.

### (Production of Resin Foam)

Each component shown in the resin foam column of Table 2 was fed into a single screw extruder, melted and kneaded at 120° C., and extruded to form a 2.4 mm thick resin sheet (resin composition). The resin sheet was crosslinked by irradiating both surfaces of the resin sheet with an electron beam at an acceleration voltage of 500 kV and an irradiation dose of 5.5 Mrad. Then, the crosslinked resin sheet was heated in a hot air oven at 240° C. for 3 minutes. The heat caused the resin sheet to foam, whereby a resin foam having a thickness of 6 mm was obtained. The surfaces of the 6 mm resin foams were heated to 80° C., and successively laminated to obtain a 12 mm resin foam.

### (Production of Laminated Structure)

A laminated body was produced by stacking the metal sheet and the resin foam. Then, the metal sheet surface of the laminated body was heated at a heating temperature of 150° C. for about 5 seconds, and after compressing the laminated body by hand, the laminated body was cooled to produce a laminated structure.

### Examples 9 and 13 and Reference Examples 1 to 3

The number of metal layers in the metal sheet, the thickness of one metal layer, the total thickness of the metal layers, and the number of first resin layers were changed as shown in Table 2 by changing the thickness and number of layers of the aluminum foil used for the metal sheet and the number of layers of the flame-retardant polyethylene sheet to be laminated. Other than that, the metal sheets and the laminated structures of Examples 9 and 13 and Reference Examples 1 to 3 were produced in the same manner as the metal sheet and the laminated structure of Example 8.

### Example 10

One sheet of an aluminum glass cloth in which 18 μm aluminum foil and a glass cloth having a basis weight of 14 g/m² were adhered, one sheet of 18 μm aluminum foil, and two flame-retardant polyethylene sheets (trade name “FP-PF”, manufactured by Asahi Sangyo Co., Ltd.) (PE) were prepared. The glass cloth that was used was a glass net.

The sheets of PE and aluminum foil were alternately stacked on the surface on the glass cloth side of the aluminum glass cloth to obtain a laminated body having a layer structure of Al foil/glass cloth/PE/Al foil/PE. This laminated body was stuck together by heating at a temperature of 130° C. to produce a metal sheet. Other than that, a metal sheet having two metal layers, a metal layer thickness of 18 μm, a first resin layer provided between adjacent metal layers, and a second resin layer and a glass cloth layer arranged on one surface of the metal sheet was produced in the same manner as in Example 8.

### Example 11

Two sheets of an aluminum glass cloth in which 18 μm aluminum foil and a glass cloth having a basis weight of 14 g/m² were adhered, two sheets of 18 μm aluminum foil, and four flame-retardant polyethylene sheets (trade name “FP-PF”, manufactured by Asahi Sangyo Co., Ltd.) (PE) were prepared. The glass cloth that was used was a glass net.

The sheets of PE and aluminum glass cloth or aluminum foil were alternately stacked on the surface on the glass cloth side of the aluminum glass cloth to obtain a laminated body having a layer structure of Al foil/glass cloth/PE/Al foil/glass cloth/PE/Al foil/PE/Al foil/PE. This laminated body was stuck together by heating at a temperature of 130° C. to produce a metal sheet. Other than that, a metal sheet having four metal layers, a metal layer thickness of 18 μm, a first resin layer provided between adjacent metal layers, and a second resin layer and a glass cloth layer arranged on one surface of the metal sheet was produced in the same manner as in Example 8.

### Example 12

One sheet of an aluminum glass cloth in which 25 μm aluminum foil and a glass cloth having a basis weight of 14 g/m² were adhered, three sheets of 25 μm aluminum foil, and four flame-retardant polyethylene sheets (trade name “FP-PF”, manufactured by Asahi Sangyo Co., Ltd.) (PE) were prepared. The glass cloth that was used was a glass net.

The sheets of PE and aluminum foil were alternately stacked on the surface on the glass cloth side of the aluminum glass cloth to obtain a laminated body having a layer structure of Al foil/glass cloth/PE/Al foil/PE/Al foil/PE/Al foil/PE. This laminated body was stuck together by heating at a temperature of 130° C. to produce a metal sheet. Other than that, a metal sheet having four metal layers, a metal layer thickness of 25 μm, a first resin layer provided between adjacent metal layers, and a second resin layer and a glass cloth layer arranged on one surface of the metal sheet was produced in the same manner as in Example 8.

The evaluation results of the laminated structures of each of the examples and reference examples are shown in Table 2.

TABLE 2

| | | | Example | | | | | | Reference Example | | |
|---|---|---|---|---|---|---|---|---|---|---|---|
| | | | 8 | 9 | 10 | 11 | 12 | 13 | 1 | 2 | 3 |
| Metal | Metal layer | Metal layer material | alumi- | alumi- | alumi- | alumi- | alumi- | alumi- | alumi- | alumi- | alumi- |
| sheet | | | num | num | num | num | num | num | num | num | num |
| | | Number of metal layers | 3 | 2 | 2 | 4 | 2 | 2 | 1 | 1 | 1 |
| | | Thickness of one | 12 | 17 | 18 | 18 | 25 | 35 | 35 | 80 | 60 |
| | | metal layer (μm) | | | | | | | | | |
| | | Total thickness of | 36 | 34 | 36 | 72 | 50 | 70 | 35 | 80 | 60 |
| | | metal layers (Ta) (μm) | | | | | | | | | |
| | First | Material of first | PE | PE | PE | PE | PE | PE | — | — | — |
| | resin layer | resin layer | | | | | | | | | |
| | | Number of first | 2 | 1 | 1 | 3 | 1 | 1 | — | — | — |
| | | resin layers | | | | | | | | | |
| | | Thickness of one first | 15 | 15 | 15 | 15 | 15 | 15 | — | — | — |
| | | resin layer (μm) | | | | | | | | | |
| | Second | Material of second | PE | PE | PE | PE | PE | PE | PE | PE | PE |
| | resin layer | resin layer | | | | | | | | | |
| | | Thickness of second | 15 | 15 | 15 | 15 | 15 | 15 | 15 | 15 | 15 |
| | | resin layer (μm) | | | | | | | | | |
| | Glass | Number of glass | — | — | 1 | 2 | 1 | — | — | — | — |
| | cloth layer | cloth layers | | | | | | | | | |
| | | Basis weight of glass | — | — | 14 | 14 | 14 | — | — | — | — |
| | | cloth layer (g/m²) | | | | | | | | | |
| | Thickness of metal sheet (μm) | | 81 | 64 | 145 | 290 | 160 | 100 | 50 | 95 | 75 |
| Resin | Blend | LDPE | 100 parts | | | | | | | | |
| foam | | Brominated | 6 parts | | | | | | | | |
| | | fire retardant | | | | | | | | | |
| | | Antimony trioxide | 3 parts | | | | | | | | |
| | | Zinc stearate | 2.2 parts | | | | | | | | |
| | | Antioxidant | 0.4 parts | | | | | | | | |
| | | ADCA | 30 parts | | | | | | | | |
| | Density (kg/m³) | | 25 | | | | | | | | |
| | Thickness (Tb) (mm) | | 12 | | | | | | | | |
| | Degree of crosslinking (%) | | 28 | | | | | | | | |
| Evaluation | Thickness ratio (Ta/Tb) | | 3.0 | 2.8 | 3.0 | 6.0 | 4.2 | 5.8 | 2.9 | 6.7 | 5.0 |
| | Tear | Measurement | 1.2 | 0.5 | 2.7 | 5.6 | 2.6 | 0.9 | 0.4 | 1.7 | 1.1 |
| | strength | value (N) | | | | | | | | | |
| | | Judgement | ◯ | ◯ | ⊚ | ⊚ | ⊚ | ◯ | X | ◯ | ◯ |
| | Reduction in | Measurement | 1.2 | 1.0 | 0.9 | 0.9 | 1.0 | 1.0 | 1.0 | 1.5 | 1.3 |
| | thickness of | value (mm) | | | | | | | | | |
| | resin foam due | Judgement | ◯ | ◯ | ◯ | ◯ | ◯ | ◯ | ◯ | X | X |
| | to buckling of | | | | | | | | | | |
| | laminated | | | | | | | | | | |
| | structure | | | | | | | | | | |

| | | | | | | | | | |
|---|---|---|---|---|---|---|---|---|---|
| Overall judgement | ◯ | ◯ | ◯ | ◯ | ◯ | ◯ | X | X | X |

The details of each component in Table 2 are as follows.
PE Flame-retardant polyethylene sheet (trade name “FP-PF”, manufactured by Asahi Sangyo Co., Ltd.)
LDPE: Manufactured by Ube-Maruzen Polyethylene Co., Ltd., trade name “522N”
Brominated flame retardant: 1,2-bis(2,3,4,5,6-pentabromophenyl)ethane, manufactured by Albemarle Japan, trade name “SAYTEX8010”
Antimony trioxide: Nihon Seiko Co., Ltd., trade name “PATOX-M”
Zinc stearate: Manufactured by Sakai Chemical Industry Co., Ltd., trade name “SZ-2000”
Antioxidant: Manufactured by BASF Japan Ltd., trade name “Irganox 1010”
ADCA: Azodicarbonamide, foaming agent

In the metal sheet of each of the above examples, the number of metal layers is two or more, a first resin layer is provided between adjacent metal layers, the total thickness of the metal layers is 50 μm or less, and the tear strength of the metal sheet is 0.5 N or more, and therefore the tear strength was high and the metal sheet was difficult to tear. Moreover, even when adhered to a resin foam and bent, hardly any deformation due to the bending remained in the resin foam.

On the other hand, in the metal sheets of Reference Examples 1 and 2, since a first resin layer was not provided between adjacent metal layers, the tear strength was insufficient and the metal sheet tended to tear, or, since the thickness of the metal layers was more than 50 μm, deformation of the resin foam due to bending was large.

In addition, the flame retardancy of the laminated structure and the fire resistant property due to the metal sheet were also evaluated.

### (6) Flame Spread Index (FSI) and Smoke-Developed Index (SDI)

The flame spread index (FSI) and the smoke-developed index (SDI) were measured and evaluated in the same manner as in the first examples.

### (7) Evaluation of Fire Resistant Property Due to Metal Sheet

(i) A rectangular test piece was produced by cutting the laminated structure into a size of 305 mm×90 mm.
(ii) The test piece was fixed at an angle of 45 degrees from the horizontal with the metal sheet facing down.
(iii) A flame having a height of 38 mm from a Bunsen burner with an internal diameter of 9.5 mm was brought into contact with a central portion of the metal sheet for 90 seconds.
(iv) The melted or burned depth in the thickness direction of the resin foam at the flame-contacted portion was measured and judged according to the following criteria.
Circle: Depth of melting or burning in the thickness direction of the resin foam of 20 mm or less
Cross: Depth of melting or burning in the thickness direction of the resin foam of more than 20 mm

### Example 14

### (Production of Resin Foam)

Each component shown in the resin foam column of Table 3 was fed into a single screw extruder, melted and kneaded at 120° C., and extruded to form a 2 mm thick resin sheet (resin composition). The resin sheet was crosslinked by irradiating both surfaces of the resin sheet with an electron beam at an acceleration voltage of 500 kV and an irradiation dose of 5.5 Mrad. Then, the crosslinked resin sheet was heated in a hot air oven at 240° C. for 3 minutes. The heat caused the resin sheet to foam, whereby a resin foam having a thickness of 5 mm was obtained. The surfaces of the 5 mm resin foams were heated to 80° C., and successively laminated to obtain a 40 mm resin foam.

### (Production of Laminated Structure)

The metal sheet of Example 10 was arranged on the resin foam so that the resin foam and the second resin layer of the metal sheet of Example 10 were in contact, and then the resin foam and the metal sheet of Example 10 were laminated together by heating to 150° C. from the metal sheet side to obtain a laminated structure.

### Example 15

The laminated structure of Example 14 was produced in the same manner as the laminated structure of Example 14, except that the metal sheet of Example 11 was used instead of the metal sheet of Example 10.

### Example 16

The laminated structure of Example 15 was produced in the same manner as the laminated structure of Example 14, except that the metal sheet of Example 12 was used instead of the metal sheet of Example 10.

### Example 17

The laminated structure of Example 17 was produced in the same manner as the laminated structure of Example 14, except that the thickness of the resin foam was changed from 40 mm to 25 mm.

### Example 18

The laminated structure of Example 18 was produced in the same manner as the laminated structure of Example 14, except that the metal sheet of Example 11 was used instead of the metal sheet of Example 10 and the thickness of the resin foam was changed from 40 mm to 50 mm.

### Example 19

The laminated structure of Example 19 was produced in the same manner as the laminated structure of Example 14, except that the metal sheet of Example 13 was used instead of the metal sheet of Example 10 and the thickness of the resin foam was changed from 40 mm to 50 mm.

The evaluation results of the laminated structures of Examples 14 to 19 are shown in Table 3.

TABLE 3

| | | | Laminated structure | | | | | |
|---|---|---|---|---|---|---|---|---|
| | | | Example 14 | Example 15 | Example 16 | Example 17 | Example 18 | Example 19 |
| | | | Metal sheet | | | | | |
| | | | Example 10 | Example 11 | Example 12 | Example 10 | Example 11 | Example 13 |
| Resin foam | Blend | LDPE | 100 parts | 100 parts | 100 parts | 100 parts | 100 parts | 100 parts |
| | | Brominated fire | 6 parts | 6 parts | 6 parts | 6 parts | 6 parts | 6 parts |
| | | retardant | | | | | | |
| | | Antimony trioxide | 3 parts | 3 parts | 3 parts | 3 parts | 3 parts | 3 parts |
| | | Zinc stearate | 2.2 parts | 2.2 parts | 2.2 parts | 2.2 parts | 2.2 parts | 2.2 parts |
| | | Antioxidant | 0.4 parts | 0.4 parts | 0.4 parts | 0.4 parts | 0.4 parts | 0.4 parts |
| | | ADCA | 30 parts | 30 parts | 30 parts | 30 parts | 30 parts | 30 parts |
| | Density (kg/m³) | | 25 | 25 | 25 | 25 | 25 | 25 |
| | Degree of crosslinking (%) | | 28 | 28 | 28 | 28 | 28 | 28 |
| | Thickness (Tb) (mm) | | 40 | 40 | 40 | 25 | 50 | 50 |
| Thickness ratio (Ta/Tb) | | | 0.9 | 1.8 | 1.3 | 1.4 | 1.4 | 1.4 |
| Fire- | Flame spread | Evaluation | 10 | 20 | 30 | 5 | 20 | — |
| retardant | index (FSI) | Judgement | ⊚ | ⊚ | ◯ | ⊚ | ⊚ | — |
| ASTM E84 | Smoke- | Evaluation | 300 | 45 | 120 | 140 | 15 | — |
| | developed | Judgement | ◯ | ⊚ | ◯ | ◯ | ⊚ | — |
| | index (SDI) | | | | | | | |

| | | | | | | |
|---|---|---|---|---|---|---|
| Overall judgement | ◯ | ⊚ | ◯ | ◯ | ⊚ | — |

| | | | | | | | |
|---|---|---|---|---|---|---|---|
| Evaluation of fire | Evaluation (mm) | 12 | 8.5 | 10 | 12 | 8.5 | 9 |
| resistant property | Judgement | ◯ | ◯ | ◯ | ◯ | ◯ | ◯ |
| due to metal sheet | | | | | | | |

The details of each component in Table 3 are as follows.
LDPE: Manufactured by Ube-Maruzen Polyethylene Co., Ltd., trade name “522N”
Brominated flame retardant: 1,2-bis(2,3,4,5,6-pentabromophenyl)ethane, manufactured by Albemarle Japan, trade name “SAYTEX8010”
Antimony trioxide: Nihon Seiko Co., Ltd., trade name “PATOX-M”
Zinc stearate: Manufactured by Sakai Chemical Industry Co., Ltd., trade name “SZ-2000”
Antioxidant: Manufactured by BASF Japan Ltd., trade name “Irganox 1010”
ADCA: Azodicarbonamide, foaming agent

As shown in Table 3, it was found that flame retardancy and fire resistant property can be imparted to a laminated structure by using the metal sheets of the examples.

### REFERENCE SIGNS LIST

1A to 1G laminated structure
10A to 10G metal sheet
11 metal layer
12 resin layer
12a first resin layer
12b second resin layer
13 cloth layer (glass cloth layer)
20 resin foam
30 pressure-sensitive adhesion layer

1. A laminated structure comprising:
a metal sheet formed by laminating two or more metal layers; and
a resin foam,
the laminated structure having a total thickness of the metal layers in the metal sheet, Ta (μm), and a thickness of the resin foam, Tb (mm), satisfying the relationship of the following formula (1):
$$Ta / Tb \geq 0.7 . \qquad ( 1 )$$

2. The laminated structure according to claim 1, wherein each of the metal layers has a thickness of 10 μm or more.

3. The laminated structure according to claim 1, wherein the metal sheet comprises a resin layer provided between adjacent metal layers.

4. The laminated structure according to claim 1 wherein the resin foam has a thickness of from 25 to 76 mm.

5. The laminated structure according to claim 1, wherein the metal sheet further comprises a cloth layer provided between adjacent metal layers.

6. The laminated structure according to claim 1, wherein at least one metal layer in the metal sheet is an aluminum layer.

7. The laminated structure according to claim 1, wherein the resin foam comprises a flame retardant.

8. The laminated structure according to claim 1, further comprising a pressure-sensitive adhesion layer provided on a surface of the resin foam opposite to the surface facing the metal sheet.

9. The laminated structure according to claim 1, wherein
the metal sheet comprises a first resin layer provided between adjacent metal layers,
the thickness of each of the metal layers is 50 μm or less, and
the metal sheet has a tear strength of 0.5 N or more.

10. The laminated structure according to claim 9, wherein each of the metal layers has a thickness of 10 μm or more.

11. The laminated structure according to claim 9, wherein the resin constituting the first resin layer comprises a polyolefin resin.

12. The laminated structure according to claim 9, comprising a second resin layer provided on one surface.

13. The laminated structure according to claim 12, wherein the resin constituting the second resin layer comprises a polyolefin resin.

14. The laminated structure according to claim 9, further comprising a reinforcement cloth layer provided between adjacent metal layers.

15. The laminated structure according to claim 9, wherein at least one metal layer is an aluminum layer.

16. The laminated structure according to claim 9, wherein a total thickness of the metal layers is 100 μm or less.

17. The laminated structure according to claim 9, wherein the metal sheet has a thickness of 400 μm or less.

18. The laminated structure according to claim 9, further comprising a pressure-sensitive adhesion layer provided on a surface of the resin foam opposite to the surface facing the metal sheet.
